(19) United States
(12) Patent Application Publication
(10) Pub. No.: US 2026/0181466 A1
(43) Pub. Date: Jun. 25, 2026

(54) PROTOCOL DATA UNIT SET COMMUNICATIONS VIA MULTIPLE ACCESS LINKS IN WIRELESS COMMUNICATIONS

(71) Applicant: QUALCOMM Incorporated, San Diego, CA (US)

(72) Inventors: Diana MAAMARI, San Diego, CA (US); Dario Serafino TONESI, San Diego, CA (US); Mickael MONDET, Louannec (FR); Sunghoon KIM, San Diego, CA (US); Peerapol TINNAKORNSRISUPHAP, San Diego, CA (US); Hong CHENG, Basking Ridge, NJ (US); Prashanth Haridas HANDE, San Diego, CA (US)

(21) Appl. No.: 18/989,358

(22) Filed: Dec. 20, 2024

(51) Int. Cl. H04W 28/02; H04W 28/08; H04W 76/15

(52) U.S. Cl. CPC H04W 28/0268; H04W 28/0925; H04W 76/15

(57) ABSTRACT

Methods, systems, and devices for wireless communications are described that provide that a user equipment (UE) can establish two or more links with a network entity for transfer of protocol data units (PDUs) associated with a data flow. Each PDU of the data flow may be associated with a PDU set, where a PDU set includes two or more PDUs that are each associated with a same set of data such as a same frame or video slice, and different PDU sets associated with the data flow may be entirely transmitted via one of the links. Traffic steering, switching, or splitting rules may provide that each PDU of a PDU set is transmitted via a same link. In some cases, for traffic switching the UE and the network entity may change access links after a data flow is started, which may be done with a PDU set quantum.

### FIELD OF TECHNOLOGY

The following relates to wireless communications, including protocol data unit set communications via multiple access links in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information for a first quality of service (QoS) flow to be communicated via a first link with a network entity and a second link with the network entity, where the first QoS flow includes a set of multiple protocol data unit (PDU) sets and each PDU set of the set of multiple PDU sets includes a set of multiple PDUs and transmitting the set of multiple PDU sets to the network entity via one or more of the first link or the second link, where different PDU sets within the set of multiple PDU sets are entirely transmitted via either the first link or the second link, and each PDU of a PDU set is transmitted via a same link.

A UE for wireless communications is described. The UE may include one or more memories storing processor executable code, and one or more processors coupled with the one or more memories. The one or more processors may individually or collectively be operable to execute the code to cause the UE to receive configuration information for a first QoS flow to be communicated via a first link with a network entity and a second link with the network entity, where the first QoS flow includes a set of multiple PDU sets and each PDU set of the set of multiple PDU sets includes a set of multiple PDUs and transmit the set of multiple PDU sets to the network entity via one or more of the first link or the second link, where different PDU sets within the set of multiple PDU sets are entirely transmitted via either the first link or the second link, and each PDU of a PDU set is transmitted via a same link.

Another UE for wireless communications is described. The UE may include means for receiving configuration information for a first QoS flow to be communicated via a first link with a network entity and a second link with the network entity, where the first QoS flow includes a set of multiple PDU sets and each PDU set of the set of multiple PDU sets includes a set of multiple PDUs and means for transmitting the set of multiple PDU sets to the network entity via one or more of the first link or the second link, where different PDU sets within the set of multiple PDU sets are entirely transmitted via either the first link or the second link, and each PDU of a PDU set is transmitted via a same link.

A non-transitory computer-readable medium storing code for wireless communications is described. The code may include instructions executable by one or more processors to receive configuration information for a first QoS flow to be communicated via a first link with a network entity and a second link with the network entity, where the first QoS flow includes a set of multiple PDU sets and each PDU set of the set of multiple PDU sets includes a set of multiple PDUs and transmit the set of multiple PDU sets to the network entity via one or more of the first link or the second link, where different PDU sets within the set of multiple PDU sets are entirely transmitted via either the first link or the second link, and each PDU of a PDU set is transmitted via a same link.

Some examples of the method, UEs, and non-transitory computer-readable medium described herein may further include operations, features, means, or instructions for selecting the first link for transmission of a first PDU set of the set of multiple PDU sets based on one or more access traffic steering-switching-splitting (ATSSS) rules, and where each PDU of the first PDU set is entirely transmitted via the first link and selecting the second link for transmission of a second PDU set of the set of multiple PDU sets based on the one or more ATSSS rules, and where each PDU of the second PDU set is entirely transmitted via the second link.

In some examples of the method, UEs, and non-transitory computer-readable medium described herein, the first link provides access to the network entity via a first access link of a cellular network between the UE and the network entity, and the second link provides access to the network entity via either a second access link of the cellular network or a non-cellular link that uses a different radio access technology than the first link.

In some examples of the method, UEs, and non-transitory computer-readable medium described herein, the first link provides access to the network entity via a first access link of the UE and the second link provides access to the network entity via a cooperative link with a different UE that has a second access link with the network entity.

Some examples of the method, UEs, and non-transitory computer-readable medium described herein may further include operations, features, means, or instructions for selecting the first link for transmission of a first PDU set of the set of multiple PDU sets based on a PDU set importance (PSI) associated with the first PDU set having a highest PSI value and the first link providing a higher throughput than the second link and selecting the second link for transmission of a second PDU set of the set of multiple PDU sets based on the PSI associated with the second PDU set having a lower PSI value than the first PDU set and the second link providing a lower throughput than the first link.

Some examples of the method, UEs, and non-transitory computer-readable medium described herein may further include operations, features, means, or instructions for selecting one of the first link or the second link for transmission of a first PDU set of the set of multiple PDU sets based on a PDU set importance (PSI) associated with the first PDU set having a highest PSI value and the first link providing a shorter delay than other available links.

Some examples of the method, UEs, and non-transitory computer-readable medium described herein may further include operations, features, means, or instructions for selecting one of the first link or the second link for transmission of a first PDU set of the set of multiple PDU sets based on steering mode rules, where the steering mode rules provide prioritization of a link based on one or more of an available or unavailable link, a round trip time associated with each link, a load balancing target associated with each link, or an assigned priority associated with each link.

In some examples of the method, UEs, and non-transitory computer-readable medium described herein, the set of multiple PDU sets include a first subset of PDU sets associated with a first multimodal flow of a multimodal service associated with the first QoS flow, and a second subset of PDU sets associated with a second multimodal flow of the multimodal service, and where the first subset of PDU sets is mapped to a different link than the second subset of PDU sets.

Some examples of the method, UEs, and non-transitory computer-readable medium described herein may further include operations, features, means, or instructions for receiving one or more link reports that indicate one or more of a round trip time or an error rate associated with each of the first link and the second link and selecting one of the first link or the second link for mapping the first subset of PDU sets based on the one or more link reports.

Some examples of the method, UEs, and non-transitory computer-readable medium described herein may further include operations, features, means, or instructions for selecting the first link or the second link for transmission of a first PDU set of the set of multiple PDU sets based on steering pattern of a load balancing steering mode.

In some examples of the method, UEs, and non-transitory computer-readable medium described herein, the steering pattern is indicted in the configuration information as an index value that identifies the steering pattern from multiple available steering patterns, or the steering pattern is provided with a QoS associated with the QoS flow.

In some examples of the method, UEs, and non-transitory computer-readable medium described herein, the first link is associated with a first subscriber identification module (SIM) of the UE, and the second link is associated with a second subscriber identity module (SIM) of the UE, and link selection of the first link or the second link for transmission of one or more PDU sets of the set of multiple PDU sets is based on a dual steer profile associated with concurrent connections of the first SIM and the second SIM.

A method for wireless communications by a network entity is described. The method may include configuring a first QoS flow at a UE, the first QoS flow to be communicated via a first link with the UE and a second link with the UE, where the first QoS flow includes a set of multiple PDU sets and each PDU set of the set of multiple PDU sets includes a set of multiple PDUs and outputting the set of multiple PDU sets for transmission to the UE via one or more of the first link or the second link, where different PDU sets within the set of multiple PDU sets are entirely transmitted via either the first link or the second link, and each PDU of a PDU set is transmitted via a same link.

A network entity for wireless communications is described. The network entity may include one or more memories storing processor executable code, and one or more processors coupled with the one or more memories. The one or more processors may individually or collectively be operable to execute the code to cause the network entity to configure a first QoS flow at a UE, the first QoS flow to be communicated via a first link with the UE and a second link with the UE, where the first QoS flow includes a set of multiple PDU sets and each PDU set of the set of multiple PDU sets includes a set of multiple PDUs and output the set of multiple PDU sets for transmission to the UE via one or more of the first link or the second link, where different PDU sets within the set of multiple PDU sets are entirely transmitted via either the first link or the second link, and each PDU of a PDU set is transmitted via a same link.

Another network entity for wireless communications is described. The network entity may include means for configuring a first QoS flow at a UE, the first QoS flow to be communicated via a first link with the UE and a second link with the UE, where the first QoS flow includes a set of multiple PDU sets and each PDU set of the set of multiple PDU sets includes a set of multiple PDUs and means for outputting the set of multiple PDU sets for transmission to the UE via one or more of the first link or the second link, where different PDU sets within the set of multiple PDU sets are entirely transmitted via either the first link or the second link, and each PDU of a PDU set is transmitted via a same link.

A non-transitory computer-readable medium storing code for wireless communications is described. The code may include instructions executable by one or more processors to configure a first QoS flow at a UE, the first QoS flow to be communicated via a first link with the UE and a second link with the UE, where the first QoS flow includes a set of multiple PDU sets and each PDU set of the set of multiple PDU sets includes a set of multiple PDUs and output the set of multiple PDU sets for transmission to the UE via one or more of the first link or the second link, where different PDU sets within the set of multiple PDU sets are entirely transmitted via either the first link or the second link, and each PDU of a PDU set is transmitted via a same link.

Some examples of the method, network entities, and non-transitory computer-readable medium described herein may further include operations, features, means, or instructions for selecting the first link for transmission of a first PDU set of the set of multiple PDU sets based on one or more ATSSS rules, and where each PDU of the first PDU set is entirely transmitted via the first link and selecting the second link for transmission of a second PDU set of the set of multiple PDU sets based on the one or more ATSSS rules, and where each PDU of the second PDU set is entirely transmitted via the second link.

In some examples of the method, network entities, and non-transitory computer-readable medium described herein, the first link is a first access link of a cellular network between the UE and the network entity, and the second link provides access to the UE via either a second access link of the cellular network or a non-cellular link that uses a different radio access technology than the first link.

In some examples of the method, network entities, and non-transitory computer-readable medium described herein, the UE is a first UE and the first link is a first access link of a cellular network between the first UE and the network entity, and the second link includes a second access link with a second UE and a cooperative link between the first UE and the second UE.

Some examples of the method, network entities, and non-transitory computer-readable medium described herein may further include operations, features, means, or instructions for selecting the first link for transmission of a first PDU set of the set of multiple PDU sets based on a PDU set importance (PSI) associated with the first PDU set having a highest PSI value and the first link providing a higher throughput than the second link and selecting the second link for transmission of a second PDU set of the set of multiple PDU sets based on the PSI associated with the second PDU set having a lower PSI value than the first PDU set and the second link providing a lower throughput than the first link.

Some examples of the method, network entities, and non-transitory computer-readable medium described herein may further include operations, features, means, or instructions for selecting one of the first link or the second link for transmission of a first PDU set of the set of multiple PDU sets based on a PSI associated with the first PDU set having a highest PSI value and the first link providing a shorter delay than other available links.

Some examples of the method, network entities, and non-transitory computer-readable medium described herein may further include operations, features, means, or instructions for selecting one of the first link or the second link for transmission of a first PDU set of the set of multiple PDU sets based on steering mode rules, where the steering mode rules provide prioritization of a link based on one or more of an available or unavailable link, a round trip time associated with each link, a load balancing target associated with each link, or an assigned priority associated with each link.

In some examples of the method, network entities, and non-transitory computer-readable medium described herein, the set of multiple PDU sets include a first subset of PDU sets associated with a first multimodal flow of a multimodal service associated with the first QoS flow, and a second subset of PDU sets associated with a second multimodal flow of the multimodal service, and where the first subset of PDU sets is mapped to a different link than the second subset of PDU sets.

Some examples of the method, network entities, and non-transitory computer-readable medium described herein may further include operations, features, means, or instructions for obtaining one or more link reports that indicate one or more of a round trip time or an error rate associated with each of the first link and the second link and selecting one of the first link or the second link for mapping the first subset of PDU sets based on the one or more link reports.

Some examples of the method, network entities, and non-transitory computer-readable medium described herein may further include operations, features, means, or instructions for selecting the first link or the second link for transmission of a first PDU set of the set of multiple PDU sets based on steering pattern of a load balancing steering mode.

In some examples of the method, network entities, and non-transitory computer-readable medium described herein, the steering pattern is indicted in configuration information provided to the UE as an index value that identifies the steering pattern from multiple available steering patterns, or the steering pattern is provided with a QoS associated with the QoS flow.

In some examples of the method, network entities, and non-transitory computer-readable medium described herein, the first link is associated with a first SIM of the UE, and the second link is associated with a second SIM of the UE, and link selection of the first link or the second link for transmission of one or more PDU sets of the set of multiple PDU sets is based on a dual steer profile associated with concurrent connections of the first SIM and the second SIM.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports protocol data unit set communications via multiple access links in wireless communications in accordance with one or more aspects of the present disclosure.

FIG. 2 shows an example of a wireless communications system that supports protocol data unit set communications via multiple access links in wireless communications in accordance with one or more aspects of the present disclosure.

FIG. 3 shows an example of a flow splitting and aggregation functionality that supports protocol data unit set communications via multiple access links in wireless communications in accordance with one or more aspects of the present disclosure.

FIG. 4 shows an example of a multiple access protocol data unit (PDU) session architecture that supports protocol data unit set communications via multiple access links in wireless communications in accordance with one or more aspects of the present disclosure.

FIG. 5 shows an example of a process flow that supports protocol data unit set communications via multiple access links in wireless communications in accordance with one or more aspects of the present disclosure.

FIGS. 6 and 7 show block diagrams of devices that support protocol data unit set communications via multiple access links in wireless communications in accordance with one or more aspects of the present disclosure.

FIG. 8 shows a block diagram of a communications manager that supports protocol data unit set communications via multiple access links in wireless communications in accordance with one or more aspects of the present disclosure.

FIG. 9 shows a diagram of a system including a device that supports protocol data unit set communications via multiple access links in wireless communications in accordance with one or more aspects of the present disclosure.

FIGS. 10 and 11 show block diagrams of devices that support protocol data unit set communications via multiple access links in wireless communications in accordance with one or more aspects of the present disclosure.

FIG. 12 shows a block diagram of a communications manager that supports protocol data unit set communications via multiple access links in wireless communications in accordance with one or more aspects of the present disclosure.

FIG. 13 shows a diagram of a system including a device that supports protocol data unit set communications via multiple access links in wireless communications in accordance with one or more aspects of the present disclosure.

FIGS. 14 through 22 show flowcharts illustrating methods that support protocol data unit set communications via multiple access links in wireless communications in accordance with one or more aspects of the present disclosure.

### DETAILED DESCRIPTION

In some wireless deployments, one or more devices, such as a user equipment (UE) may transmit a series of transmissions to a network device, such as a network entity of a wireless communications network. For example, UE may be a virtual reality (VR) or augmented reality (AR) device, collectively referred to as XR devices, and may transmit data in data flows that data over a relatively long period of time (e.g., scene data and related refreshed scene data may be periodically transmitted for a duration of time that a user is using an XR device). In some cases, a UE may have a relatively constrained space that is available for radio, processing, and power supply components. For example, a UE may be an XR device that is implemented as a wearable device of a user, such as AR glasses that have a form factor that allows for a relatively small amount of radio components, processing circuitry components, and battery components. In some cases, radio transceiver components in such devices may have reduced functionality relative to UEs that have a larger form factor (such as handset UEs), such as fewer radio frequency (RF) chains (e.g., a wearable device may have two RF chains with two associated antennas, and a handset UE may have eight RF chains with eight associated antennas). In some cases, the quantity of RF chains, number of antennas (e.g., receive and/or transmit antennas) and limited power and/or thermal budgets of such devices may not allow for sufficient communications bandwidth to meet quality of service (QoS) targets for a data flow (which may be referred to as a QoS flow), which may result in a degraded user experience.

In accordance with various aspects as discussed herein, a first UE, such as an XR device, may coordinate with a cooperating device, such as a cooperating wearable device, to provide a second communication path for a QoS flow between the UE and a network entity. For example, the first UE may be a pair of XR glasses worn by a user, and may establish a cooperative link with a second UE associated with the user. The second UE may be another wearable UE (e.g., a watch) or with a handset UE of the user, and provide an associated second link with the network entity. The connection of the cooperative link may use a different radio access technology than a first link between the first UE and the network entity, such as a Wi-Fi connection, a sidelink or PC5 connection, an ultra-wideband (UWB) connection, a near field communications connection, and the like. The cooperative link may provide a second path between the first UE and the network entity, which can add bandwidth to the communications of the QoS flow, can ass antennas associated with the QoS flow, can provide additional power or thermal budget, can provide additional transmit power, or any combination thereof. Such a cooperative link may thus provide, relative to using only the first link, better XR key performance indicators (KPIs), through one or more of lower latency, higher throughput, higher reliability, better coverage, or any combination thereof. In some cases, traffic may be split between the first link and the second link in accordance with access traffic steering-switching-splitting (ATSSS) rules. However, ATSSS rules may route protocol data units (PDUs) associated with a particular XR application data unit, such as a frame, video slice, or video burst, where PDUs of such a data unit (referred to herein as a “PDU set”) may be routed via different links. In some cases, PDUs of a PDU set may be associated with a same QoS flow, and routing such PDUs via different links may result in KPIs associated with the QoS flow that may not be met due to the splitting (at the transmit side) and aggregation (at the receive side) of the PDUs. As discussed herein, PDU sets refer to are one or more PDUs carrying payload of a unit of information generated at application level (e.g., frame(s) or video slices(s) etc.).

In accordance with various aspects discussed herein, techniques may provide that a UE can establish a connection with a network entity via two (or more) links for a QoS flow, or multiple QoS flows, and different PDU sets associated with the QoS flow may be entirely transmitted via one of the links. In some aspects, ATSSS, as well as dual steer (e.g., for multiple connections via multiple subscriber identity modules (SIMs)) may be implemented to enable traffic steering, traffic switching, and traffic splitting, where each PDU of a PDU set is transmitted via a same link (e.g., a PDU set of a QoS flow can either be sent entirely over a first link or entirely over a second link, but not partially over both and, depending on the steering mode, all PDU sets of a QoS flow may be sent over the same link or over different links). In some aspects, it may be beneficial for the at least one or more XR devices (e.g., AR glasses, wearable device, etc.) to apply traffic steering and/or switching between two 3GPP access networks connected to the same or different PLMN networks. It is also possible that the two access networks can be one 3GPP and one non 3GPP network. In some implementations, the steering functionality MPQUIC (multipath Quick UDP Internet Connection (QUIC)) or MPTCP (multipath TCP) can be utilized to enable the steering, switching, and splitting of UDP (user datagram protocol) or TCP (transmission control protocol) traffic. In some implementations, the device(s) supporting traffic steering, switching, and splitting may be two separate UEs in case of simultaneous data transmission over the two networks and the subscriber has two subscription profiles/SUPIs (subscription permanent identifier) sharing one subscription profile from the same operator. In some aspects, in cases of traffic splitting (e.g., 60% of the traffic of a QoS data flow goes over a first link and the remaining 40% over a second link) link selection takes into account that PDU sets are transferred in their entirety on a link. In some aspects, for traffic switching the UE and the network entity may change access links after a QoS flow is started, which may be done with a PDU set quantum. Additionally, or alternatively, link selection rules may provide that a link may be selected for a PDU set based on a priority associated with a PDU set and a link congestion or link latency. In some further aspects, additionally, or alternatively, a dual steer device may transmit all PDUs of a PDU set using only a single 3GPP access network, and may transmit subsequent PDUs of a second PDU set using a second 3GPP access network (or non 3GPP access network). In some alternative aspects, a radio access network (RAN) and/or UE may be allowed to split PDUs of a PDU set across two connections only conditionally, such as based on conditions that may depend on one or more of a quality of the two associated access links and a UE-to-UE connection state, where quality may be in terms of reliability, latency, capacity, or any combination thereof.

Particular aspects of the subject matter described in this disclosure can be implemented to realize one or more of the following potential advantages. In some implementations, for example, by performing link selection from two or more links between a network entity and a UE in which an entire PDU set is transmitted via a same link, system efficiency and reliability may be enhanced through avoidance of splitting and aggregation of PDUs of a PDU set, while also providing enhanced bandwidth through the use of multiple links. Further, in the event one or more uplink transmission occasions are skipped, a skipping indication may allow for a receiving device to avoid trying to decode the associated resources, or reuse the associated resources, thereby enhancing system efficiency. Further, link selection rules that provide a PDU set via a link based on link congestion or latency may enhance KPI metrics and provide a more enjoyable user experience.

Aspects of the disclosure are initially described in the context of wireless communications systems. Aspects of the disclosure are further illustrated by and described with reference to flow splitting and aggregation functionality, multiple access PDU sessions, process flows, apparatus diagrams, system diagrams, and flowcharts that relate to protocol data unit set communications via multiple access links in wireless communications.

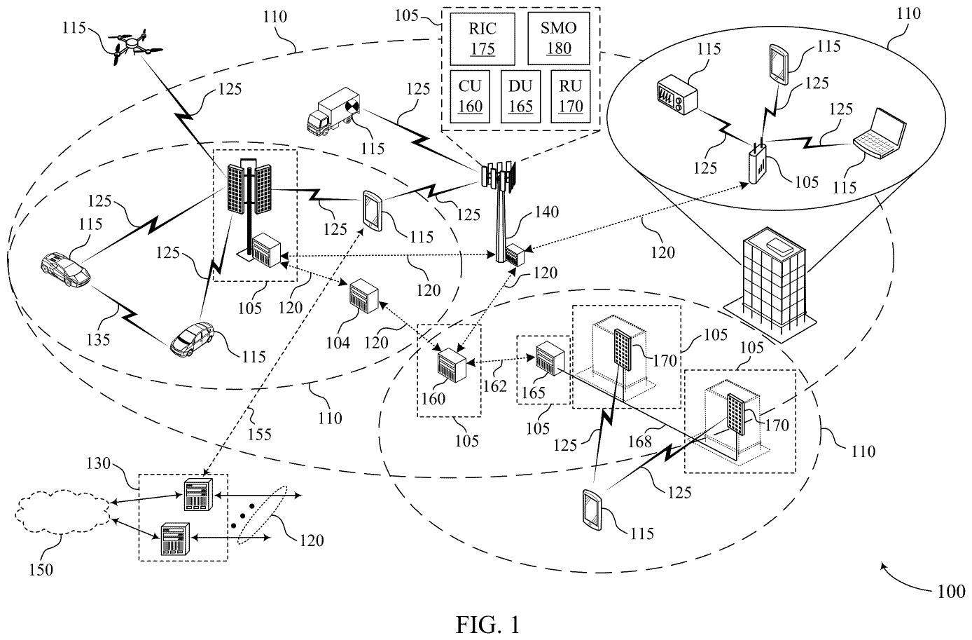

FIG. 1 shows an example of a wireless communications system 100 that supports protocol data unit set communications via multiple access links in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support protocol data unit set communications via multiple access links in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects a UE 115 can establish a connection with a network entity 105 via two or more links, and a QoS flow may be transmitted over the multiple links. In some aspects, different PDU sets associated with the QoS flow may be entirely transmitted via one of the links. In some aspects, ATSSS, as well as dual steer, may be implemented to enable traffic steering, traffic switching, and traffic splitting, where each PDU of a PDU set is transmitted via a same link. In some aspects, in cases of traffic splitting (e.g., 60% of the traffic of a QoS data flow goes over a first link and the remaining 40% over a second link) link selection may take into account that PDU sets are transferred in their entirety on one link when making a link selection. In some aspects, for traffic switching the UE 115 and the network entity 105 may change access links after a QoS flow is started, which may be done with a PDU set quantum. Additionally, or alternatively, link selection rules may provide that a link may be selected for a PDU set based on a priority associated with a PDU set and a link congestion or link latency.

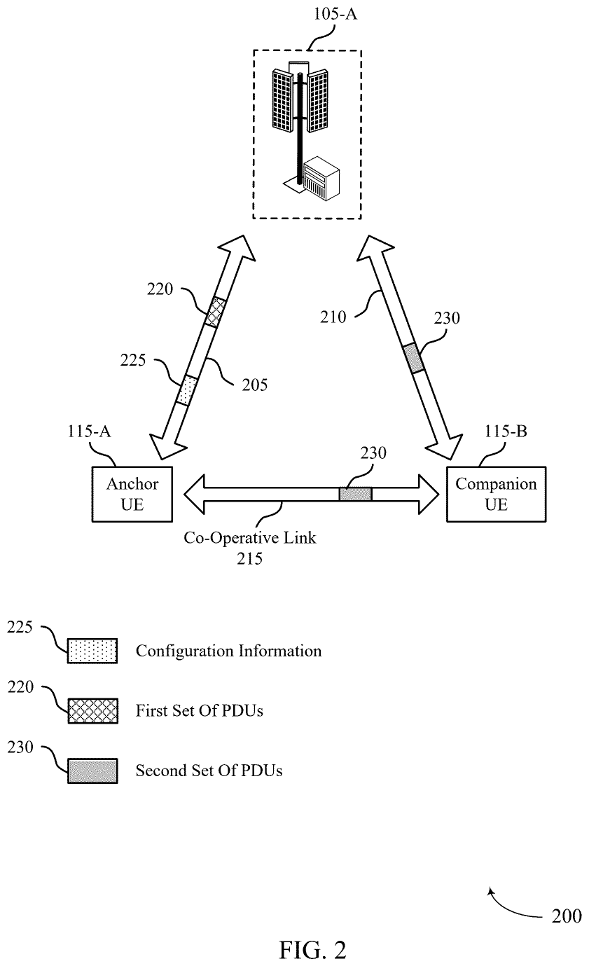

FIG. 2 shows an example of a wireless communications system 200 that supports protocol data unit set communications via multiple access links in wireless communications in accordance with one or more aspects of the present disclosure. In some examples, wireless communications system 200 may implement aspects of wireless communications system 100. In the example of FIG. 2, wireless communications system 200 may include a network entity 105-a, a first UE 115-a, which may be referred to as an anchor UE, and a second UE 115-b, which may be referred to as a companion UE. The network entity 105-a, first UE 115-a, and second UE 115-b may be examples of the corresponding devices described with respect to FIG. 1.

In accordance with various aspects, the first UE 115-a may establish a first link with the network entity 105-a via a first connection 205 (e.g., a connection via a Uu interface), and may establish a second link with the network entity 105-a via the second UE 115-b. The second connection may be established using a cooperative link 215 between the first UE 115-a and the second UE 115-b (e.g., a PC5 link, a sidelink, a Wi-Fi link, etc.), and a second link 210 between the second UE 115-b and the network entity 105-a. As discussed herein, in some aspects, the first UE 115-a may establish one or more QoS flows with the network entity 105-a (such as a QoS flow between an application client at the first UE 115-a and an application server that is accessed via the network entity 105-a). In some aspects, the network entity 105-a may transmit configuration information 225 to the UE 115-a that configures one or more QoS flows. The first UE 115-a may transmit a first set of PDUs 220 associated with the QoS flow to the network entity 105-a via the first link, and a second set of PDUs 230 associated with the QoS flow to the network entity 105-a via the second link.

In some examples, as discussed herein, the anchor UE may be a wearable device (e.g., AR glasses) that has two receive chains and two associated antennas, and the companion UE may be another wearable device (e.g., a watch) that may have one receive chain and one associated antenna. In such examples, cooperative communications of the anchor UE and the companion UE may provide a total of three receive chains, which may substantially increase data throughput at the anchor UE, while meeting power and thermal limits associated with the wearable devices (e.g., about 500 mW). Such techniques may provide for an enhanced XR experience by a user of the anchor UE, that may have relatively high KPIs (e.g., a data rate of about 10-100 Mbps, a latency of about 10-30 msec, and a reliability based on a PER of about 1×10⁻³). In some example, the cooperative link 215 between the anchor UE and the companion UE may be a Wi-Fi or UWB (high frequency) link, although any suitable radio access technology, or tethered communications, may be used for the cooperative link 215, and two separate Uu connections may be used for the QoS flow between the anchor UE and the network entity 105-a.

In some aspects, access traffic steering, switching, and splitting (ATSSS) rules may be used to select which of the first link or the second link is used to transmit a PDU set between the anchor UE and the network entity 105-a. In some aspects, the anchor UE may use ATSSS rules to determine how to split uplink PDU sets, where an entirety of an uplink PDU set is transmitted using a same link. Further, a user plane function (UPF) of the network entity 105-a may use ATSSS rules to determine how to split downlink PDU sets, where an entirety of a PDU set is transmitted using a same link. In some implementations, a performance measurement function (PMF) may be used to provide input as to which link should be selected for a set of PDUs. In some cases, at session establishment, if measurement assistance information (MAI) is sent to the anchor UE, it may be used to determine which measurements to perform over the two links and if to report them to the network entity 105-a. PMF protocol (PMFP) procedures may be performed between PMF in UE and PMF in UPF, such as UPF and UE-initiated round trip time (RTT) measurements (e.g., that may be used for a “smallest delay” steering mode), and/or a UE-initiated access unavailability/availability report sent to UPF (e.g., that may allow the network entity 105-a to detect unavailability sooner and prevent the UPF from sending downlink packets to an unavailable access for too long from a user experience perspective). In some cases, the MAI may include PMF addressing information in the UPF for the anchor UE to send PMFP messages, where the addressing information may include, for an IP type PDU Session, an IP address for PMF and two user datagram protocol (UDP) ports (one for each access), or for an Ethernet type PDU Session, two MAC addresses (one for each access). In some cases, the UE and UPF may perform RTT measurements by using multipath TCP (MPTCP) layer instead of the PMF.

In accordance with some aspects as discussed herein, the first UE 115-a and the network entity 105-a may support PDU set-based traffic steering with multiple access (MA) PDUs, where the selection of a link for a PDU set is supported by the functionality of a MA-PDU session establishment with at least two connections supporting PDU sets. Additionally, ATSSS rules, dual steer rules, or other steering rules (e.g., 6G steering rules/modes) may perform link selection that is based on aspects related to XR QoS flows, such as transmission of entire PDU sets via one link for XR, multimodality, XR KPIs, PDU set importance, and the like. In various aspects, link selection rules may provide for traffic steering, in which initial access selection when a service data flow is, or is about to be, transferred (e.g., when the related PDU session/QoS flow is established). Further, the link selection rules may provide for traffic switching, in which a change of a link after the communication has been established is performed. Additionally, the link selection rules may provide for traffic splitting, in which a determination on how to split the traffic of the same service data flow over the two accesses is made. In various aspects, link selection may be performed at the PDU level based on selected links transferring PDU sets in their entirety on a same link. In some cases, in case of traffic splitting (e.g., 60% of the traffic of a service data flow goes over the first link and the remaining 40% over the second link) link selection is performed based on transfer of PDU sets (rather that at an individual PDU level). For traffic switching the same rules apply at the time of switching, and when the first UE 115-a and the UPF change access (e.g., according to the logic indicated by the session management function (SMF) in ATSSS rules) this change is performed with a PDU set quantum (e.g., not within a PDU set).

In some aspects, the first UE 115-a (for uplink communications) or UPF at the network entity 105-a (for downlink communications), based on the indication that the QoS flow is for PDU sets and based on implementation, may select a link to ensure that the PDUs of a given PDU set are not sent over two accesses. For example, network entity 105 at the SMF/UPF, or the first UE 115-a, may be configured to use both links for the QoS flow with PDU set handling. In other words, any given PDU set exchanged over MA PDU sessions cannot be split over two accesses. In some cases, steering modes and steering rules of established ATSSS techniques may be used in accordance with PDU sets rather than individual PDUs. For example, for a specific traffic descriptor, setting load balancing percentage 100% to the first link and 0% to the second link. Such techniques may enable support for PDU set handling in MA PDU sessions, to better meet QoS requirements for PDUs of same PDU set.

Additionally, or alternatively, ATSSS steering modes may be enhanced to consider PSI for XR traffic. In some cases, within a priority based steering mode an XR device may be allowed to map PDU sets with high PSI to be steered on one connection (e.g., the high priority access) and PDU sets with low priority PSI on the second access. For example, high PSI PDU sets may be mapped to a less congested connection or to a connection with better radio quality. In some cases, steering may be used on a shortest delay steering mode. For example, dynamic steering (based on the shortest delay) may be used, and a time window (or interval for performance measurement) may be defined that does not impact PDU set traffic transmission negatively. For example, once a PDU set transmission is started, do not change the access, and after the end of a PDU set transmission, the UE or UPF may obtain a measurement of the delay and use the shortest delay path for the next PDU set handling. In further cases, existing steering modes may be used and it is up to UE/UPF implementation to map PSI levels to proper access

In further aspects, ATSSS steering rules may be provided that support multimodal services. Multimodal services may include several data flows (referred to as multimodal flows) that are related to each other and may come from different sources. Each data flow (single-modal data) may be seen as one type of data (e.g., for audio, video, etc.) associated with the same communication service. In some cases, link selection at XR devices may map multiple PDU sets of multimodal flows of a multimodal service to the two connections (e.g., map a service data flow (SDF) on one flow and the associated multimodal flow to the other connection). In some cases, a single UE can map the two multimodal flows on the two connections, or multiple UEs can map each of the multimodal flow on the two connections (e.g., using dual steer and dual SIMs). In some cases, a smallest delay steering mode may be selected to steer an SDF to the access that is determined to have the smallest RTT and lowest PDU set error rate. In some aspects, associated devices may provide PDU set loss rate reports, in addition to existing RTT reports.

In some further aspects, one or more patterns may be configured for load balancing. For example, a load balancing steering mode may provide a flexible split of the traffic between the two connections, such as steering traffic 50% onto two connections, but loading balancing with such a split may result in different patterns for discontinuous reception (DRX), which may results in different power savings at the anchor UE due to configuration of different DRX cycles. Such patterns may include, for example, 1212121; 1122112; and 1111222, in which a ‘1’ indicates the first link and a ‘2’ indicates the second link. In some aspects, the indication to which steering pattern of a load balancing steering mode may be provided to the UE or UPF, which may be selected to provide power savings to the anchor UE. In some cases, the pattern may be provided by an indication of an index value that is mapped to a table with different patterns. In some cases, a pattern can be updated with a QoS profile update, or while updating a PDU session.

In some aspects, additionally or alternatively, techniques as discussed herein may be applied to a single UE with multiple SIMs. Further, technique may be applied to any type of MA-PDU session, such as sessions that use 3GPP and non-3GPP connections, or two 3GPP connections. Further, techniques as discussed herein may be applicable to multiple XR devices with a shared subscription profile with traffic aggregation.

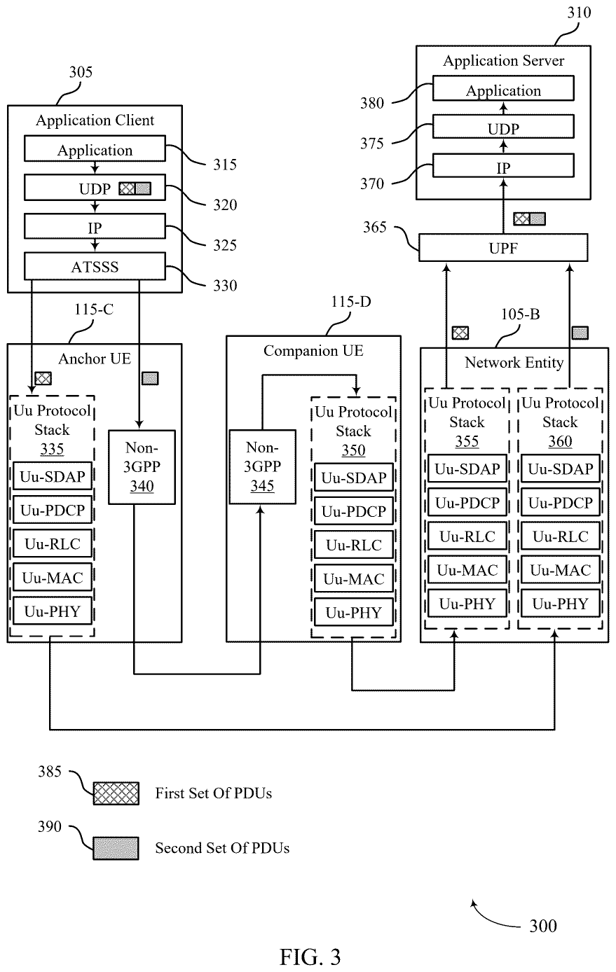

FIG. 3 shows an example of flow splitting and aggregation functionality 300 that supports protocol data unit set communications via multiple access links in wireless communications in accordance with one or more aspects of the present disclosure. In some examples, the flow splitting and aggregation functionality 300 may implement or be implemented by aspects of wireless communications system 100 or 200, as described with reference to FIGS. 1 and 2, or by a UE and one or more network entities as discussed with reference to FIGS. 1 and 2.

In this example, an anchor UE 115-c may support a QoS flow between an application client 305 and an application server 310 via a first link between the anchor UE 115-c and a network entity 105-b, and a second link via companion UE 115-d that has a separate connection with the network entity 105-b. In this example, an application 315 at application client 305 may provide data to a user datagram protocol (UDP) function 320, that may generate data for PDU sets, including a first set of PDUs 385 and a second set of PDUs 390. The sets of PDUs may be provided to an IP layer 325 which may provide PDUs of the PDU sets to the ATSSS function 330. Based on link selection at the ATSSS function 330, the first set of PDUs 385 may be provided to a Uu protocol stack 335 at the anchor UE 115-c, and the second set of PDUs 390 may be provided to a non-3GPP function 340 for transmission to companion UE 115-d (e.g., via a Wi-Fi link). The companion UE 115-d may include a non-3GPP function 345 that receives the second set of PDUs and provides them to a Uu protocol stack 350 at the companion UE 115-d. Separate Uu protocol stacks at the network entity 105-b may be present, with a first Uu protocol stack 360 that receives the first set of PDUs 385 from the anchor UE 115-c and a second Uu protocol stack 355 that receives the second set of PDUs 390 from the companion UE 115-d. The network entity 105-b may provide each set of PDUs to UPF 365, which may aggregate the PDUs from the PDU sets and provide them to application server 310 (e.g., to an IP layer 370, which provides data to UDP 375, which in turn provides data to application 380). For downlink communications from the application server 310 to the application client 305, such operations may be performed in reverse.

In some aspects, the ATSSS function 330, and the UPF 365, may use ATSSS steering mode rules. For example, a steering mode may include an Active-Standby mode to steer a Service Data Flow (SDF) on one access (Active access), when it is available, and to switch the SDF to the available other access (Standby access), when the Active access is unavailable. A Smallest Delay mode may steer an SDF to the access that is determined to have the smallest Round-Trip Time (RTT). A Load-Balancing mode may split an SDF across both accesses if both accesses are available (e.g., it may contain the percentage of the SDF traffic that should be sent over each access). A Priority-based mode may steer all the traffic of an SDF to the high priority access, until this access is determined to be congested, after which traffic may be sent over the other access. In some cases, load balancing and priority-based modes may apply only to non-guaranteed-bit-rate SDFs.

In some cases, link selection may be based at least in part on a QoS framework for exchange of PDU sets. PDU sets may include one or more PDUs carrying a payload of one unit of information generated at application level (e.g., frame(s) or video slice(s) etc.), and all the PDUs of a PDU set are transmitted within the same QoS flow. A given QoS flow either transfers unmarked PDUs or PDUs marked with PDU set information. In some cases, PDU set QoS parameters sent by a SMF to a radio access network (e.g., network entity 105-b) to establish a QoS Flow, and may include a PDU Set Error Rate (PSER) that is a maximum rate for non-congestion related packet losses; a PDU Set Delay Budget (PSDB) that is a maximum time between reception of a first PDU and delivery of last arrived PDU of a PDU Set; and a PS Integrated Handling Indication (PSIHI), that is all PDUs needed for usage of PDU Set by application layer. In some aspects, QoS parameters may apply to all PDU sets in uplink and downlink, and at least one parameter is sent to the RAN to enable PDU set handling.

In some cases, PDU set information may be provided to the RAN in a header (e.g., a GTP-U header) for downlink PDU set handling, which may include a PDU Set Sequence Number (SN); an end PDU of the PDU Set; a PDU SN within a PDU Set; a PDU set size in bytes; and a PDU Set Importance (PSI) that indicates importance of a PDU set within a QoS flow, which may be used by the RAN for PDU set level packet discarding in presence of congestion.

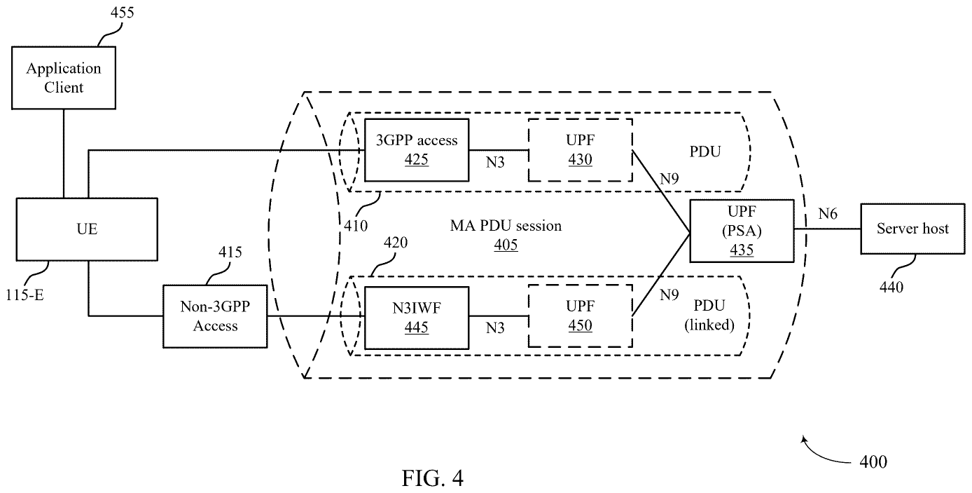

FIG. 4 shows an example of a multiple access (MA) protocol data unit (PDU) session architecture 400 that supports protocol data unit set communications via multiple access links in wireless communications in accordance with one or more aspects of the present disclosure. In some examples, the MA-PDU session architecture 400 may implement or be implemented by aspects of wireless communications system 100 or 200, as described with reference to FIGS. 1 through 3, or by a UE and one or more network entities as discussed with reference to FIGS. 1 through 3.

In this example, a UE 115-e may establish a multiple access (MA) PDU session 405 with a first PDU session 410 over a first 3GPP access 425, and a second PDU session 420 over a non-3GPP access 415. In this example, the first PDU session 410 may be provided via a first 3GPP access 425 that may use one or more network entities such as a radio head, AMF, and SMF. A first user plane function (UPF) 430 of the first PDU session 410 may provide connectivity with a PDU session anchor (PSA) UPF 435 that provides connectivity with a server host 440. Further, in the example of FIG. 4, the second PDU session 420 may be provided for non-3GPP access 415 that provides access to a non-3GPP interworking function (N3IWF) 445, which provides connectivity to UPF 450 that provides connectivity with PSA UPF 435, that provides connectivity with the server host 440. In some aspects, PDU sets associated with application client 455 may be provided via multiple links to the server host 440. Such techniques may provide for enhanced throughput between the UE 115-e and the server host 440, which may enhance user experience. Further, in some aspects, the different accesses may be tuned to provide particular services with relatively high efficiency. In some aspects, when there are resources on both accesses, link selection rules may be applied, based on local conditions to decide how to distribute UL traffic. In some aspects, an anchor UPF applies Multi-Access Rules (MAR, aka N4) rules and feedback information received from the UE 115-e (such as signal loss conditions) for deciding how to distribute traffic. In some aspects, such techniques may be supported over any type of access network (e.g., (un)trusted N3GPP, wireline access), if MA-PDU Session 405 can be established over this type of access.

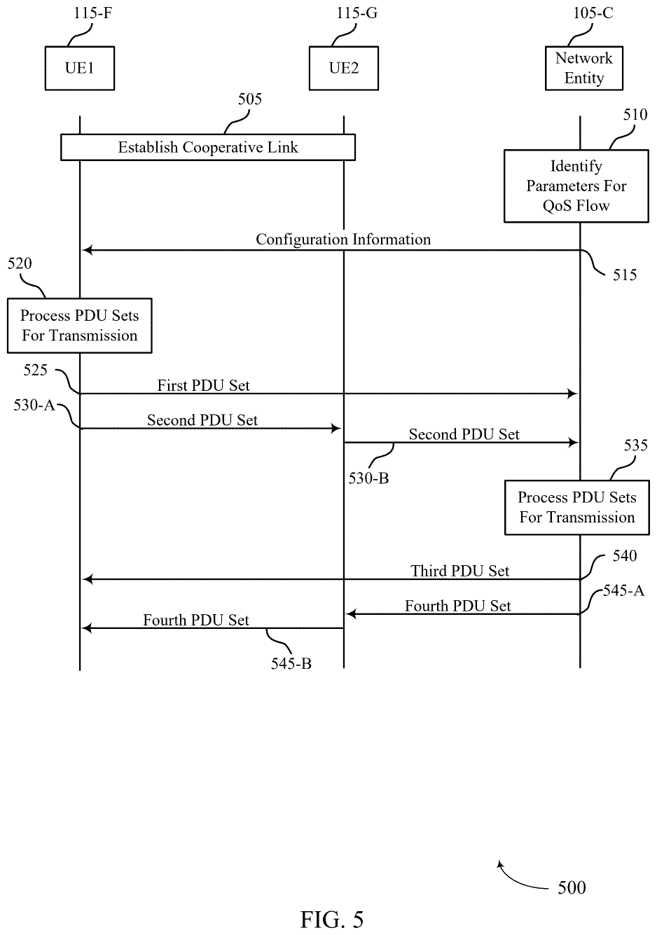

FIG. 5 shows an example of a process flow 500 that supports protocol data unit set communications via multiple access links in wireless communications in accordance with one or more aspects of the present disclosure. The process flow 500 may include a network entity 105-c that provides access to a RAN, first UE 115-f, and a second UE 115-g, which may be examples of corresponding devices as described with reference to FIGS. 1 through 4. In some cases, the process flow 500 may be implemented by the network entity 105-c and the UEs 115 when a capability indication from the UEs 115 provides an indication of support for link selection for QoS flows based on PDU sets. Such techniques may provide for enhanced throughput for data traffic associated with XR traffic flows, while also providing scheduling flexibility for data transmissions via one or both of the accesses, which may thereby enhance overall network efficiency, reduce power consumption, and enhance user experience. In the following description of the process flow 500, the operations between the network entity 105-c and UEs 115 may be performed in a different order than the example order shown. Some operations may be omitted from the process flow 500, and other operations may be added to the process flow 500.

At 505, the first UE 115-f and the second UE 115-g may establish a cooperative link. In some cases, the cooperative link may be established via a Wi-Fi connection, a sidelink connection, a PC5 connection, or a UWB connection, although any type of connection may be used.

At 510, the network entity 105-c may identify one or more parameters for a QoS flow. Such parameters may include, for example, one or more KPIs as discussed herein. At 515, the network entity 105-c may provide configuration information to the first UE 115-f.

At 520, the first UE 115-f may process PDU sets for transmission on uplink connections. In some cases, the PDU sets may be processed for transmission via different access links. For example, at 525, a first PDU set may be transmitted directly to the network entity 105-c via a Uu link of the first UE 115-f. At 530-a, the first UE 115-f may transmit a second PDU set to the second UE 115-g (e.g., via a cooperative link), and the second UE 115-g, at 530-b, may transmit the second PDU set to the network entity 105-c (e.g., via a Uu link).

At 535, the network entity 105-c may process PDU sets for downlink transmission to the first UE 115-f. In some cases, the PDU sets may be processed for transmission via different access links. For example, at 540, a third PDU set may be transmitted directly to the first UE 115-f via a Uu link of the first UE 115-f. At 545-a, the network entity 105-c may transmit a fourth PDU set to the first UE 115-f via the second UE 115-g, which then at 545-b transmits the fourth PDU set to the first UE 115-f (e.g., via the cooperative link).

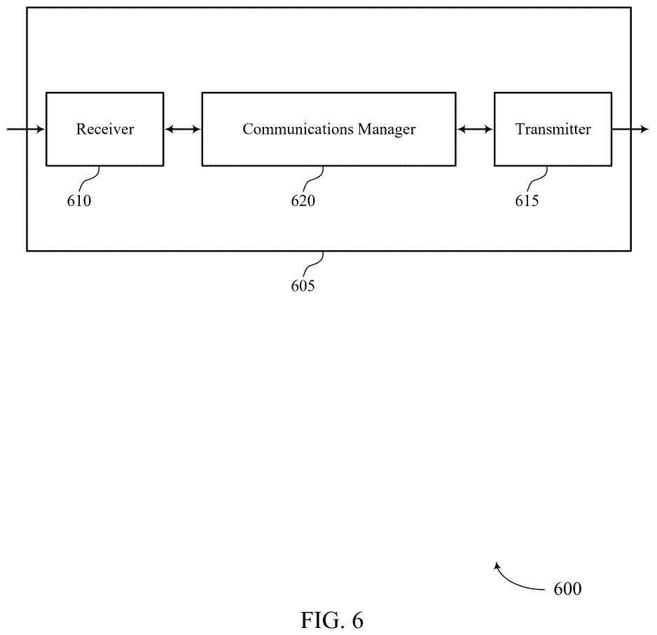

FIG. 6 shows a block diagram 600 of a device 605 that supports protocol data unit set communications via multiple access links in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to protocol data unit set communications via multiple access links in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to protocol data unit set communications via multiple access links in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of protocol data unit set communications via multiple access links in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving configuration information for a first QoS flow to be communicated via a first link with a network entity and a second link with the network entity, where the first QoS flow includes two or more PDU sets and each PDU set of the two or more PDU sets includes multiple PDUs. The communications manager 620 is capable of, configured to, or operable to support a means for transmitting the two or more PDU sets to the network entity via one or more of the first link or the second link, where different PDU sets of the two or more PDU sets are entirely transmitted via either the first link or the second link, and each PDU of a PDU set is transmitted via a same link.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for PDU set transmissions where system efficiency and reliability may be enhanced through avoidance of splitting and aggregation of PDUs of a PDU set, while also providing enhanced bandwidth through the use of multiple links.

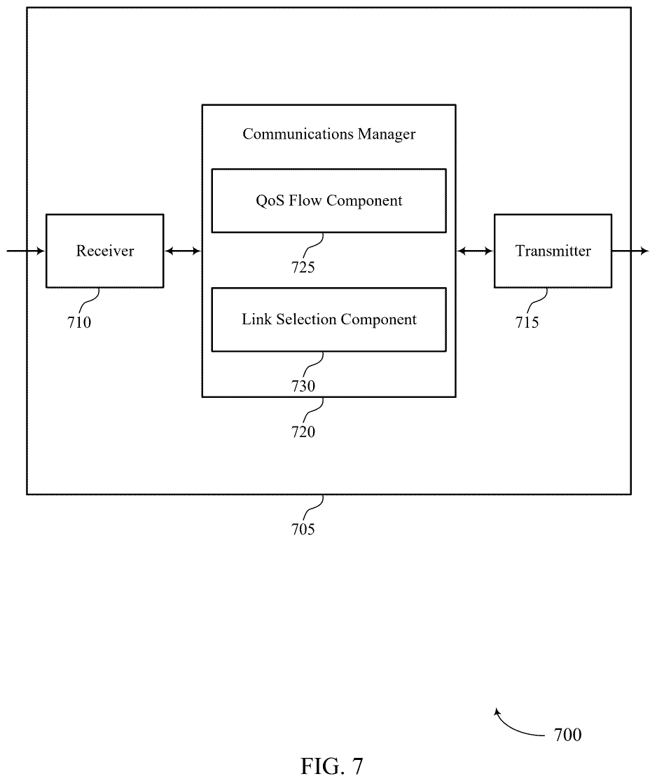

FIG. 7 shows a block diagram 700 of a device 705 that supports protocol data unit set communications via multiple access links in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to protocol data unit set communications via multiple access links in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to protocol data unit set communications via multiple access links in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of protocol data unit set communications via multiple access links in wireless communications as described herein. For example, the communications manager 720 may include a QoS flow component 725 a link selection component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The QoS flow component 725 is capable of, configured to, or operable to support a means for receiving configuration information for a first QoS flow to be communicated via a first link with a network entity and a second link with the network entity, where the first QoS flow includes two or more PDU sets and each PDU set of the two or more PDU sets includes multiple PDUs. The link selection component 730 is capable of, configured to, or operable to support a means for transmitting the two or more PDU sets to the network entity via one or more of the first link or the second link, where different PDU sets within the two or more PDU sets are entirely transmitted via either the first link or the second link, and each PDU of a PDU set is transmitted via a same link.

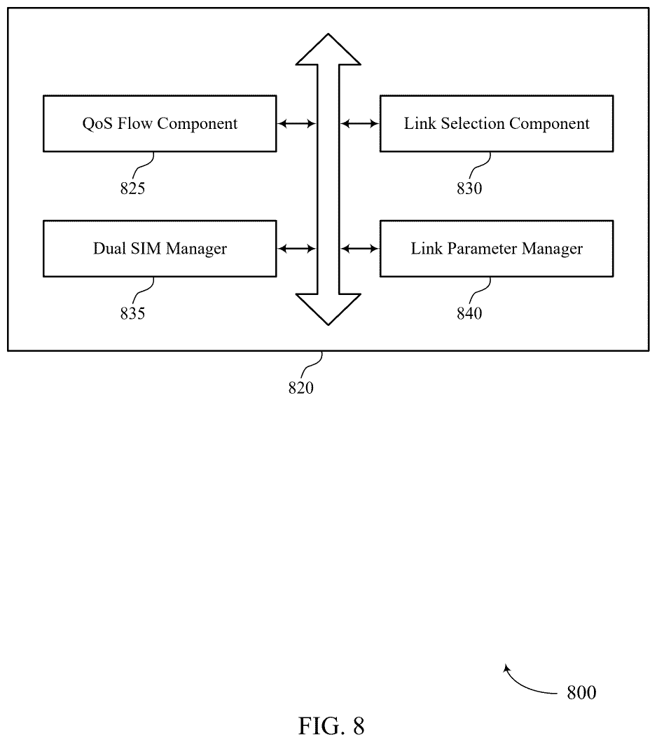

FIG. 8 shows a block diagram 800 of a communications manager 820 that supports protocol data unit set communications via multiple access links in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of protocol data unit set communications via multiple access links in wireless communications as described herein. For example, the communications manager 820 may include a QoS flow component 825, a link selection component 830, a dual SIM manager 835, a link parameter manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The QoS flow component 825 is capable of, configured to, or operable to support a means for receiving configuration information for a first QoS flow to be communicated via a first link with a network entity and a second link with the network entity, where the first QoS flow includes two or more PDU sets and each PDU set of the two or more PDU sets includes multiple PDUs. The link selection component 830 is capable of, configured to, or operable to support a means for transmitting the two or more PDU sets to the network entity via one or more of the first link or the second link, where different PDU sets within the two or more PDU sets are entirely transmitted via either the first link or the second link, and each PDU of a PDU set is transmitted via a same link.

In some examples, the link selection component 830 is capable of, configured to, or operable to support a means for selecting the first link for transmission of a first PDU set of the two or more PDU sets based on one or more ATSSS rules, and where each PDU of the first PDU set is entirely transmitted via the first link. In some examples, the link selection component 830 is capable of, configured to, or operable to support a means for selecting the second link for transmission of a second PDU set of the two or more PDU sets based on the one or more ATSSS rules, and where each PDU of the second PDU set is entirely transmitted via the second link.

In some examples, the first link provides access to the network entity via a first access link of a cellular network between the UE and the network entity, and the second link provides access to the network entity via either a second access link of the cellular network or a non-cellular link that uses a different radio access technology than the first link. In some examples, the first link provides access to the network entity via a first access link of the UE and the second link provides access to the network entity via a cooperative link with a different UE that has a second access link with the network entity.

In some examples, the link selection component 830 is capable of, configured to, or operable to support a means for selecting the first link for transmission of a first PDU set of the two or more PDU sets based on a PSI associated with the first PDU set having a highest PSI value and the first link providing a higher throughput than the second link. In some examples, the link selection component 830 is capable of, configured to, or operable to support a means for selecting the second link for transmission of a second PDU set of the two or more PDU sets based on the PSI associated with the second PDU set having a lower PSI value than the first PDU set and the second link providing a lower throughput than the first link.

In some examples, the link selection component 830 is capable of, configured to, or operable to support a means for selecting one of the first link or the second link for transmission of a first PDU set of the two or more PDU sets based on a PSI associated with the first PDU set having a highest PSI value and the first link providing a shorter delay than other available links.

In some examples, the link selection component 830 is capable of, configured to, or operable to support a means for selecting one of the first link or the second link for transmission of a first PDU set of the two or more PDU sets based on steering mode rules, where the steering mode rules provide prioritization of a link based on one or more of an available or unavailable link, a round trip time associated with each link, a load balancing target associated with each link, or an assigned priority associated with each link.

In some examples, the two or more PDU sets include a first subset of PDU sets associated with a first multimodal flow of a multimodal service associated with the first QoS flow, and a second subset of PDU sets associated with a second multimodal flow of the multimodal service, and where the first subset of PDU sets are mapped to a different link than the second subset of PDU sets. In some examples, the link parameter manager 840 is capable of, configured to, or operable to support a means for receiving one or more link reports that indicate one or more of a round trip time or an error rate associated with each of the first link and the second link. In some examples, the link selection component 830 is capable of, configured to, or operable to support a means for selecting one of the first link or the second link for mapping the first subset of PDU sets based on the one or more link reports.

In some examples, the link selection component 830 is capable of, configured to, or operable to support a means for selecting the first link or the second link for transmission of a first PDU set of the two or more PDU sets based on steering pattern of a load balancing steering mode. In some examples, the steering pattern is indicted in the configuration information as an index value that identifies the steering pattern from multiple available steering patterns, or the steering pattern is provided with a QoS associated with the QoS flow.

In some examples, the first link is associated with a first subscriber identification module (SIM) of the UE, and the second link is associated with a second SIM of the UE, and link selection of the first link or the second link for transmission of one or more PDU sets of the two or more PDU sets is based on a dual steer profile associated with concurrent connections of the first SIM and the second SIM.

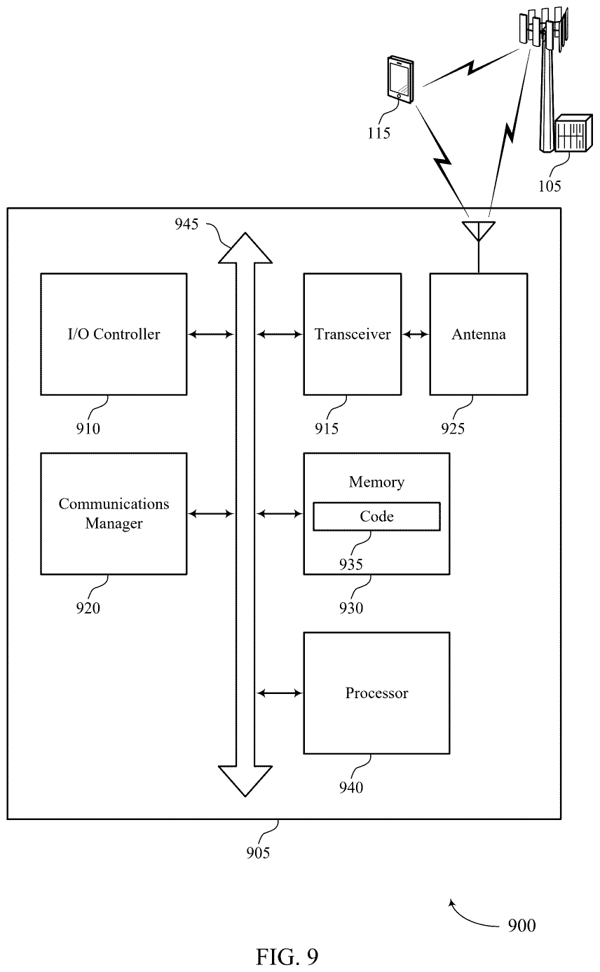

FIG. 9 shows a diagram of a system 900 including a device 905 that supports protocol data unit set communications via multiple access links in wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting protocol data unit set communications via multiple access links in wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving configuration information for a first QoS flow to be communicated via a first link with a network entity and a second link with the network entity, where the first QoS flow includes two or more PDU sets and each PDU set of the two or more PDU sets includes multiple PDUs. The communications manager 920 is capable of, configured to, or operable to support a means for transmitting the two or more PDU sets to the network entity via one or more of the first link or the second link, where different PDU sets within the two or more PDU sets are entirely transmitted via either the first link or the second link, and each PDU of a PDU set is transmitted via a same link.

By including or configuring the communications manager 920 in accordance with examples as described herein, the device 905 may support techniques for PDU set transmissions where system efficiency and reliability may be enhanced through avoidance of splitting and aggregation of PDUs of a PDU set, while also providing enhanced bandwidth through the use of multiple links.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of protocol data unit set communications via multiple access links in wireless communications as described herein, or the at least one processor 940 and the at least one memory 930 may be otherwise configured to, individually or collectively, perform or support such operations.

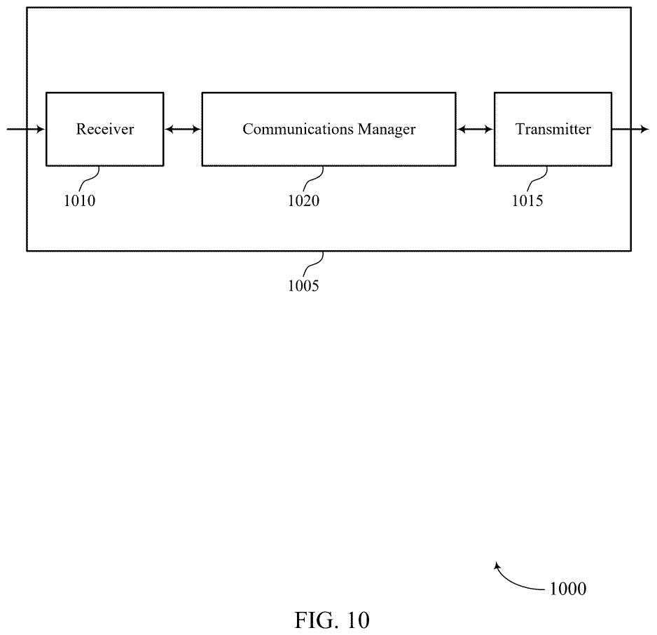

FIG. 10 shows a block diagram 1000 of a device 1005 that supports protocol data unit set communications via multiple access links in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of protocol data unit set communications via multiple access links in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for configuring a first QoS flow at a UE, the first QoS flow to be communicated via a first link with the UE and a second link with the UE, where the first QoS flow includes two or more PDU sets and each PDU set of the two or more PDU sets includes multiple PDUs. The communications manager 1020 is capable of, configured to, or operable to support a means for outputting the two or more PDU sets for transmission to the UE via one or more of the first link or the second link, where different PDU sets within the two or more PDU sets are entirely transmitted via either the first link or the second link, and each PDU of a PDU set is transmitted via a same link.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for PDU set transmissions where system efficiency and reliability may be enhanced through avoidance of splitting and aggregation of PDUs of a PDU set, while also providing enhanced bandwidth through the use of multiple links.

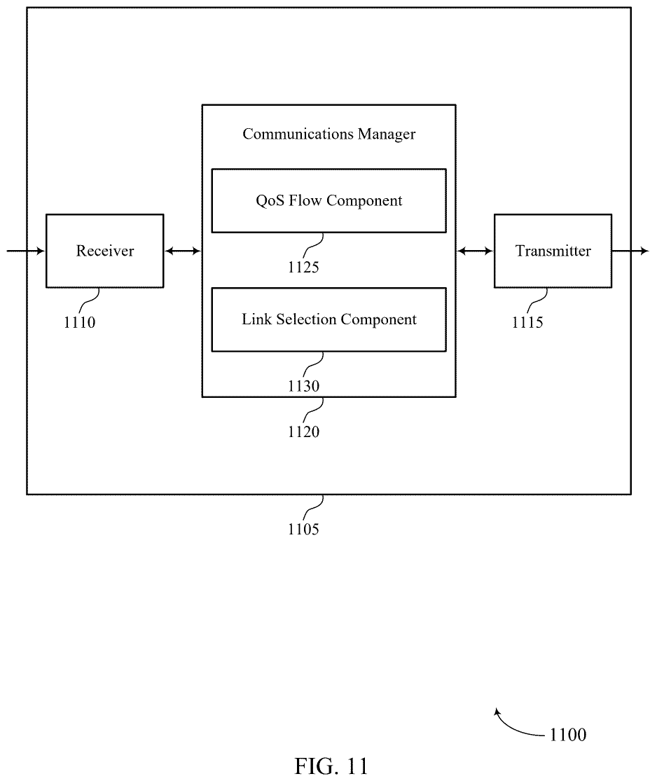

FIG. 11 shows a block diagram 1100 of a device 1105 that supports protocol data unit set communications via multiple access links in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of protocol data unit set communications via multiple access links in wireless communications as described herein. For example, the communications manager 1120 may include a QoS flow component 1125 a link selection component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The QoS flow component 1125 is capable of, configured to, or operable to support a means for configuring a first QoS flow at a UE, the first QoS flow to be communicated via a first link with the UE and a second link with the UE, where the first QoS flow includes two or more PDU sets and each PDU set of the two or more PDU sets includes multiple PDUs. The link selection component 1130 is capable of, configured to, or operable to support a means for outputting the two or more PDU sets for transmission to the UE via one or more of the first link or the second link, where different PDU sets within the two or more PDU sets are entirely transmitted via either the first link or the second link, and each PDU of a PDU set is transmitted via a same link.

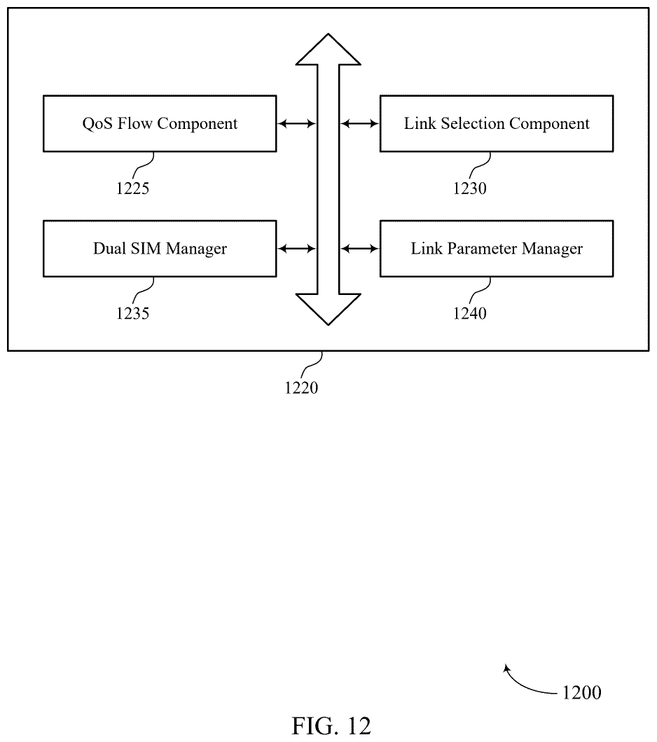

FIG. 12 shows a block diagram 1200 of a communications manager 1220 that supports protocol data unit set communications via multiple access links in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of protocol data unit set communications via multiple access links in wireless communications as described herein. For example, the communications manager 1220 may include a QoS flow component 1225, a link selection component 1230, a dual SIM manager 1235, a link parameter manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The QoS flow component 1225 is capable of, configured to, or operable to support a means for configuring a first QoS flow at a UE, the first QoS flow to be communicated via a first link with the UE and a second link with the UE, where the first QoS flow includes two or more PDU sets and each PDU set of the two or more PDU sets includes multiple PDUs. The link selection component 1230 is capable of, configured to, or operable to support a means for outputting the two or more PDU sets for transmission to the UE via one or more of the first link or the second link, where different PDU sets within the two or more PDU sets are entirely transmitted via either the first link or the second link, and each PDU of a PDU set is transmitted via a same link.

In some examples, the link selection component 1230 is capable of, configured to, or operable to support a means for selecting the first link for transmission of a first PDU set of the two or more PDU sets based on one or more ATSSS rules, and where each PDU of the first PDU set is entirely transmitted via the first link. In some examples, the link selection component 1230 is capable of, configured to, or operable to support a means for selecting the second link for transmission of a second PDU set of the two or more PDU sets based on the one or more ATSSS rules, and where each PDU of the second PDU set is entirely transmitted via the second link.

In some examples, the first link is a first access link of a cellular network between the UE and the network entity, and the second link provides access to the UE via either a second access link of the cellular network or a non-cellular link that uses a different radio access technology than the first link.

In some examples, the UE is a first UE and the first link is a first access link of a cellular network between the first UE and the network entity, and the second link includes a second access link with a second UE and a cooperative link between the first UE and the second UE.

In some examples, the link selection component 1230 is capable of, configured to, or operable to support a means for selecting the first link for transmission of a first PDU set of the two or more PDU sets based on a PSI associated with the first PDU set having a highest PSI value and the first link providing a higher throughput than the second link. In some examples, the link selection component 1230 is capable of, configured to, or operable to support a means for selecting the second link for transmission of a second PDU set of the two or more PDU sets based on the PSI associated with the second PDU set having a lower PSI value than the first PDU set and the second link providing a lower throughput than the first link.

In some examples, the link selection component 1230 is capable of, configured to, or operable to support a means for selecting one of the first link or the second link for transmission of a first PDU set of the two or more PDU sets based on a PSI associated with the first PDU set having a highest PSI value and the first link providing a shorter delay than other available links.

In some examples, the link selection component 1230 is capable of, configured to, or operable to support a means for selecting one of the first link or the second link for transmission of a first PDU set of the two or more PDU sets based on steering mode rules, where the steering mode rules provide prioritization of a link based on one or more of an available or unavailable link, a round trip time associated with each link, a load balancing target associated with each link, or an assigned priority associated with each link.

In some examples, the two or more PDU sets include a first subset of PDU sets associated with a first multimodal flow of a multimodal service associated with the first QoS flow, and a second subset of PDU sets associated with a second multimodal flow of the multimodal service, and where the first subset of PDU sets are mapped to a different link than the second subset of PDU sets. In some examples, the link parameter manager 1240 is capable of, configured to, or operable to support a means for obtaining one or more link reports that indicate one or more of a round trip time or an error rate associated with each of the first link and the second link. In some examples, the link selection component 1230 is capable of, configured to, or operable to support a means for selecting one of the first link or the second link for mapping the first subset of PDU sets based on the one or more link reports.

In some examples, the link selection component 1230 is capable of, configured to, or operable to support a means for selecting the first link or the second link for transmission of a first PDU set of the two or more PDU sets based on steering pattern of a load balancing steering mode. In some examples, the steering pattern is indicted in configuration information provided to the UE as an index value that identifies the steering pattern from multiple available steering patterns, or the steering pattern is provided with a QoS associated with the QoS flow.

In some examples, the first link is associated with a first subscriber identification module (SIM) of the UE, and the second link is associated with a second SIM of the UE, and link selection of the first link or the second link for transmission of one or more PDU sets of the two or more PDU sets is based on a dual steer profile associated with concurrent connections of the first SIM and the second SIM.

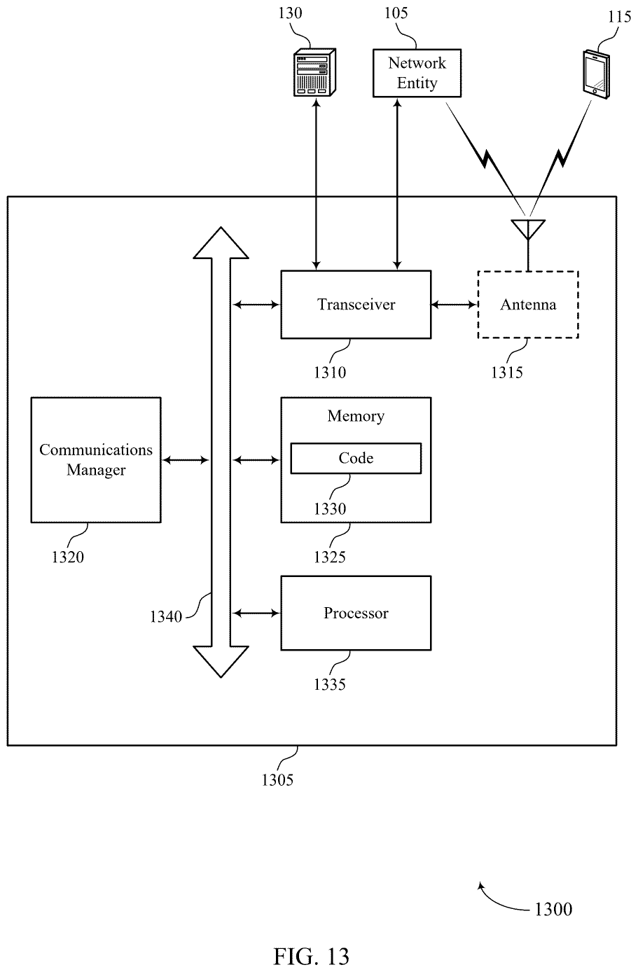

FIG. 13 shows a diagram of a system 1300 including a device 1305 that supports protocol data unit set communications via multiple access links in wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting protocol data unit set communications via multiple access links in wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for configuring a first QoS flow at a UE, the first QoS flow to be communicated via a first link with the UE and a second link with the UE, where the first QoS flow includes two or more PDU sets and each PDU set of the two or more PDU sets includes multiple PDUs. The communications manager 1320 is capable of, configured to, or operable to support a means for outputting the two or more PDU sets for transmission to the UE via one or more of the first link or the second link, where different PDU sets within the two or more PDU sets are entirely transmitted via either the first link or the second link, and each PDU of a PDU set is transmitted via a same link.

By including or configuring the communications manager 1320 in accordance with examples as described herein, the device 1305 may support techniques for PDU set transmissions where system efficiency and reliability may be enhanced through avoidance of splitting and aggregation of PDUs of a PDU set, while also providing enhanced bandwidth through the use of multiple links.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of protocol data unit set communications via multiple access links in wireless communications as described herein, or the at least one processor 1335 and the at least one memory 1325 may be otherwise configured to, individually or collectively, perform or support such operations.

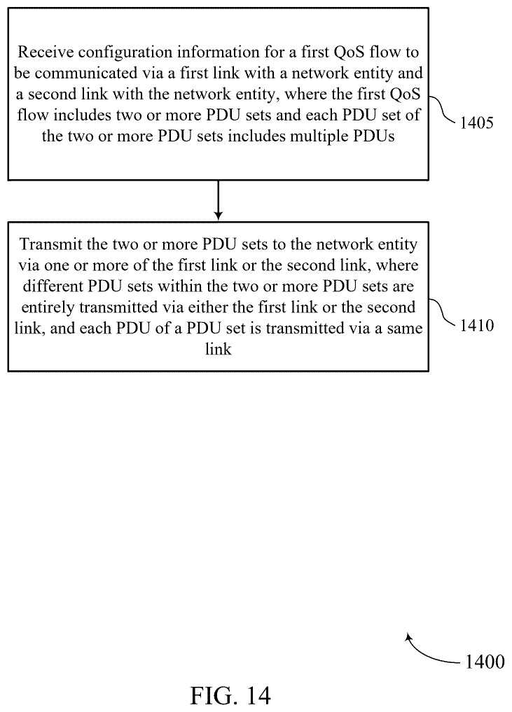

FIG. 14 shows a flowchart illustrating a method 1400 that supports protocol data unit set communications via multiple access links in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving configuration information for a first QoS flow to be communicated via a first link with a network entity and a second link with the network entity, where the first QoS flow includes two or more PDU sets and each PDU set of the two or more PDU sets includes multiple PDUs. The operations of 1405 may be performed in accordance with examples as disclosed herein. In some examples, aspects of the operations of 1405 may be performed by a QoS flow component 825 as described with reference to FIG. 8.

At 1410, the method may include transmitting the two or more PDU sets to the network entity via one or more of the first link or the second link, where different PDU sets within the two or more PDU sets are entirely transmitted via either the first link or the second link, and each PDU of a PDU set is transmitted via a same link. The operations of 1410 may be performed in accordance with examples as disclosed herein. In some examples, aspects of the operations of 1410 may be performed by a link selection component 830 as described with reference to FIG. 8.

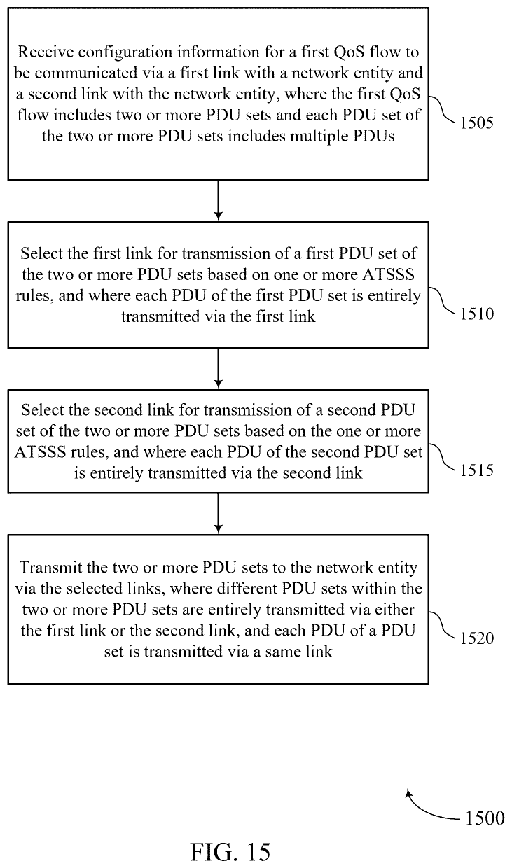

FIG. 15 shows a flowchart illustrating a method 1500 that supports protocol data unit set communications via multiple access links in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving configuration information for a first QoS flow to be communicated via a first link with a network entity and a second link with the network entity, where the first QoS flow includes two or more PDU sets and each PDU set of the two or more PDU sets includes multiple PDUs. The operations of 1505 may be performed in accordance with examples as disclosed herein. In some examples, aspects of the operations of 1505 may be performed by a QoS flow component 825 as described with reference to FIG. 8.

At 1510, the method may include selecting the first link for transmission of a first PDU set of the two or more PDU sets based on one or more ATSSS rules, and where each PDU of the first PDU set is entirely transmitted via the first link. The operations of 1510 may be performed in accordance with examples as disclosed herein. In some examples, aspects of the operations of 1510 may be performed by a link selection component 830 as described with reference to FIG. 8.

At 1515, the method may include selecting the second link for transmission of a second PDU set of the two or more PDU sets based on the one or more ATSSS rules, and where each PDU of the second PDU set is entirely transmitted via the second link. The operations of 1515 may be performed in accordance with examples as disclosed herein. In some examples, aspects of the operations of 1515 may be performed by a link selection component 830 as described with reference to FIG. 8.

At 1520, the method may include transmitting the two or more PDU sets to the network entity via the selected links, where different PDU sets within the two or more PDU sets are entirely transmitted via either the first link or the second link, and each PDU of a PDU set is transmitted via a same link. The operations of 1520 may be performed in accordance with examples as disclosed herein. In some examples, aspects of the operations of 1520 may be performed by a link selection component 830 as described with reference to FIG. 8.

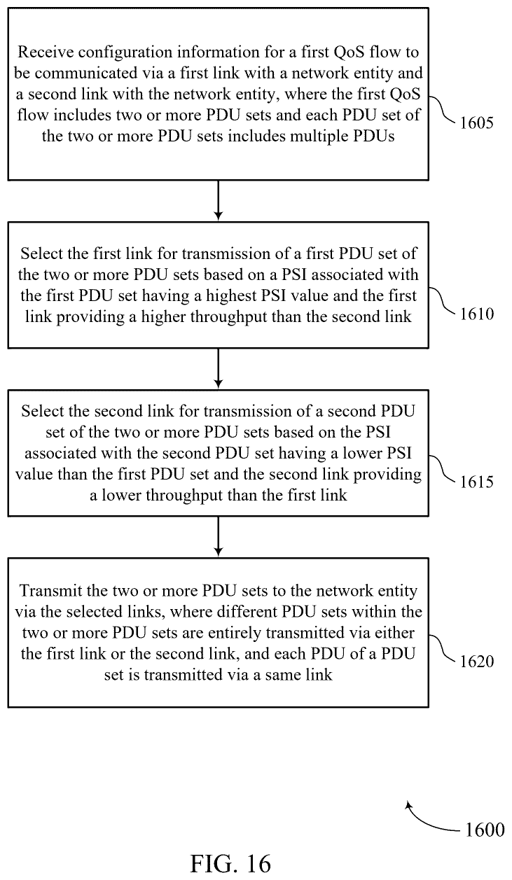

FIG. 16 shows a flowchart illustrating a method 1600 that supports protocol data unit set communications via multiple access links in wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving configuration information for a first QoS flow to be communicated via a first link with a network entity and a second link with the network entity, where the first QoS flow includes two or more PDU sets and each PDU set of the two or more PDU sets includes multiple PDUs. The operations of 1605 may be performed in accordance with examples as disclosed herein. In some examples, aspects of the operations of 1605 may be performed by a QoS flow component 825 as described with reference to FIG. 8.

At 1610, the method may include selecting the first link for transmission of a first PDU set of the two or more PDU sets based on a PSI associated with the first PDU set having a highest PSI value and the first link providing a higher throughput than the second link. The operations of 1610 may be performed in accordance with examples as disclosed herein. In some examples, aspects of the operations of 1610 may be performed by a link selection component 830 as described with reference to FIG. 8.

At 1615, the method may include selecting the second link for transmission of a second PDU set of the two or more PDU sets based on the PSI associated with the second PDU set having a lower PSI value than the first PDU set and the second link providing a lower throughput than the first link. The operations of 1615 may be performed in accordance with examples as disclosed herein. In some examples, aspects of the operations of 1615 may be performed by a link selection component 830 as described with reference to FIG. 8.

At 1620, the method may include transmitting the two or more PDU sets to the network entity via the selected links, where different PDU sets within the two or more PDU sets are entirely transmitted via either the first link or the second link, and each PDU of a PDU set is transmitted via a same link. The operations of 1620 may be performed in accordance with examples as disclosed herein. In some examples, aspects of the operations of 1620 may be performed by a link selection component 830 as described with reference to FIG. 8.

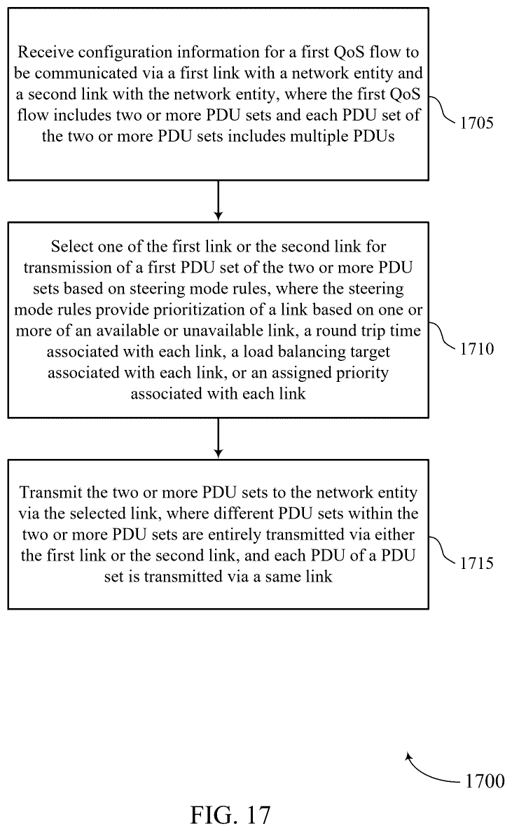

FIG. 17 shows a flowchart illustrating a method 1700 that supports protocol data unit set communications via multiple access links in wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving configuration information for a first QoS flow to be communicated via a first link with a network entity and a second link with the network entity, where the first QoS flow includes two or more PDU sets and each PDU set of the two or more PDU sets includes multiple PDUs. The operations of 1705 may be performed in accordance with examples as disclosed herein. In some examples, aspects of the operations of 1705 may be performed by a QoS flow component 825 as described with reference to FIG. 8.

At 1710, the method may include selecting one of the first link or the second link for transmission of a first PDU set of the two or more PDU sets based on steering mode rules, where the steering mode rules provide prioritization of a link based on one or more of an available or unavailable link, a round trip time associated with each link, a load balancing target associated with each link, or an assigned priority associated with each link. The operations of 1710 may be performed in accordance with examples as disclosed herein. In some examples, aspects of the operations of 1710 may be performed by a link selection component 830 as described with reference to FIG. 8.

At 1715, the method may include transmitting the two or more PDU sets to the network entity via the selected link, where different PDU sets within the two or more PDU sets are entirely transmitted via either the first link or the second link, and each PDU of a PDU set is transmitted via a same link. The operations of 1715 may be performed in accordance with examples as disclosed herein. In some examples, aspects of the operations of 1715 may be performed by a link selection component 830 as described with reference to FIG. 8.

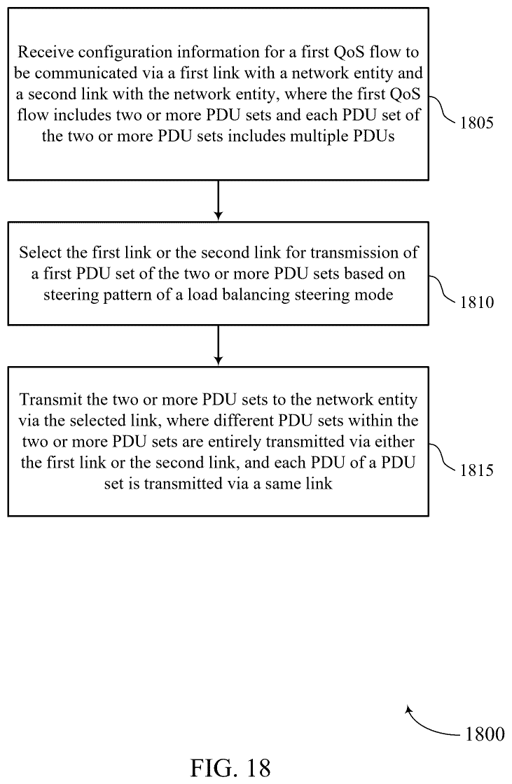

FIG. 18 shows a flowchart illustrating a method 1800 that supports protocol data unit set communications via multiple access links in wireless communications in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include receiving configuration information for a first QoS flow to be communicated via a first link with a network entity and a second link with the network entity, where the first QoS flow includes two or more PDU sets and each PDU set of the two or more PDU sets includes multiple PDUs. The operations of 1805 may be performed in accordance with examples as disclosed herein. In some examples, aspects of the operations of 1805 may be performed by a QoS flow component 825 as described with reference to FIG. 8.

At 1810, the method may include selecting the first link or the second link for transmission of a first PDU set of the two or more PDU sets based on steering pattern of a load balancing steering mode. The operations of 1810 may be performed in accordance with examples as disclosed herein. In some examples, aspects of the operations of 1810 may be performed by a link selection component 830 as described with reference to FIG. 8.

At 1815, the method may include transmitting the two or more PDU sets to the network entity via the selected link, where different PDU sets within the two or more PDU sets are entirely transmitted via either the first link or the second link, and each PDU of a PDU set is transmitted via a same link. The operations of 1815 may be performed in accordance with examples as disclosed herein. In some examples, aspects of the operations of 1815 may be performed by a link selection component 830 as described with reference to FIG. 8.

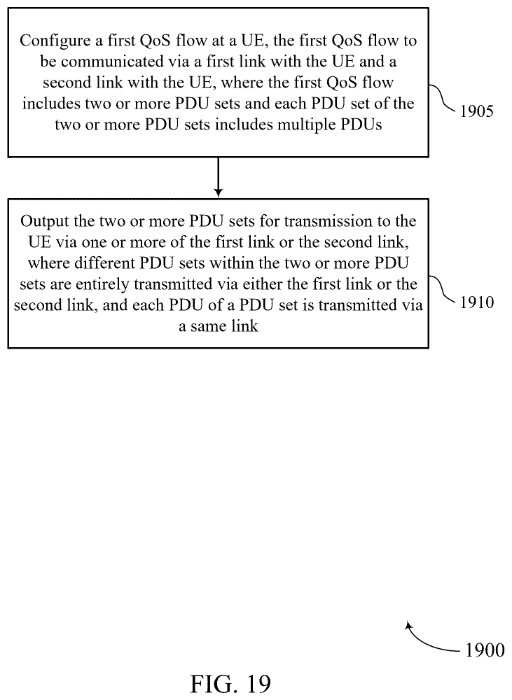

FIG. 19 shows a flowchart illustrating a method 1900 that supports protocol data unit set communications via multiple access links in wireless communications in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include configuring a first QoS flow at a UE, the first QoS flow to be communicated via a first link with the UE and a second link with the UE, where the first QoS flow includes two or more PDU sets and each PDU set of the two or more PDU sets includes multiple PDUs. The operations of 1905 may be performed in accordance with examples as disclosed herein. In some examples, aspects of the operations of 1905 may be performed by a QoS flow component 1225 as described with reference to FIG. 12.

At 1910, the method may include outputting the two or more PDU sets for transmission to the UE via one or more of the first link or the second link, where different PDU sets within the two or more PDU sets are entirely transmitted via either the first link or the second link, and each PDU of a PDU set is transmitted via a same link. The operations of 1910 may be performed in accordance with examples as disclosed herein. In some examples, aspects of the operations of 1910 may be performed by a link selection component 1230 as described with reference to FIG. 12.

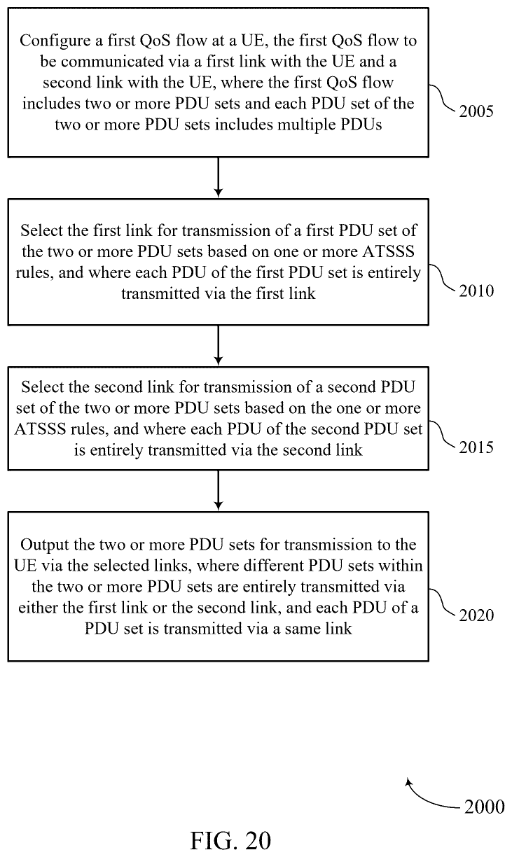

FIG. 20 shows a flowchart illustrating a method 2000 that supports protocol data unit set communications via multiple access links in wireless communications in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include configuring a first QoS flow at a UE, the first QoS flow to be communicated via a first link with the UE and a second link with the UE, where the first QoS flow includes two or more PDU sets and each PDU set of the two or more PDU sets includes multiple PDUs. The operations of 2005 may be performed in accordance with examples as disclosed herein. In some examples, aspects of the operations of 2005 may be performed by a QoS flow component 1225 as described with reference to FIG. 12.

At 2010, the method may include selecting the first link for transmission of a first PDU set of the two or more PDU sets based on one or more ATSSS rules, and where each PDU of the first PDU set is entirely transmitted via the first link. The operations of 2010 may be performed in accordance with examples as disclosed herein. In some examples, aspects of the operations of 2010 may be performed by a link selection component 1230 as described with reference to FIG. 12.

At 2015, the method may include selecting the second link for transmission of a second PDU set of the two or more PDU sets based on the one or more ATSSS rules, and where each PDU of the second PDU set is entirely transmitted via the second link. The operations of 2015 may be performed in accordance with examples as disclosed herein. In some examples, aspects of the operations of 2015 may be performed by a link selection component 1230 as described with reference to FIG. 12.

At 2020, the method may include outputting the two or more PDU sets for transmission to the UE via the selected links, where different PDU sets within the two or more PDU sets are entirely transmitted via either the first link or the second link, and each PDU of a PDU set is transmitted via a same link. The operations of 2020 may be performed in accordance with examples as disclosed herein. In some examples, aspects of the operations of 2020 may be performed by a link selection component 1230 as described with reference to FIG. 12.

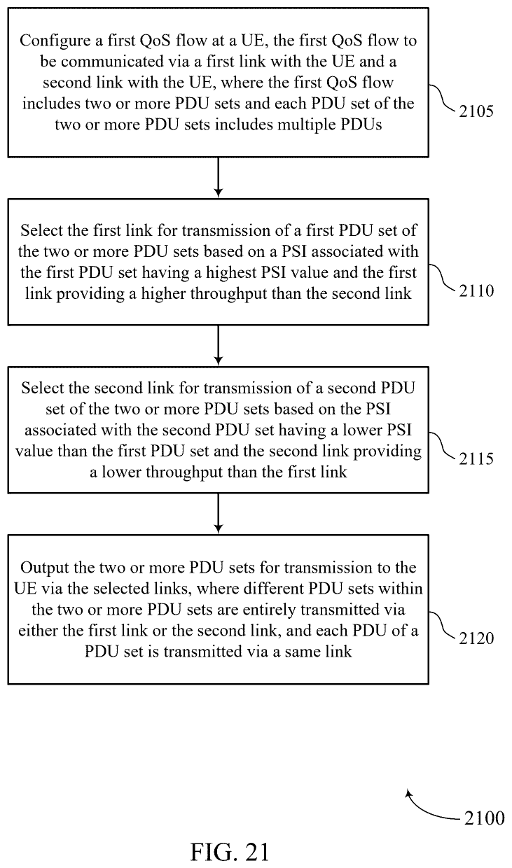

FIG. 21 shows a flowchart illustrating a method 2100 that supports protocol data unit set communications via multiple access links in wireless communications in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include configuring a first QoS flow at a UE, the first QoS flow to be communicated via a first link with the UE and a second link with the UE, where the first QoS flow includes two or more PDU sets and each PDU set of the two or more PDU sets includes multiple PDUs. The operations of 2105 may be performed in accordance with examples as disclosed herein. In some examples, aspects of the operations of 2105 may be performed by a QoS flow component 1225 as described with reference to FIG. 12.

At 2110, the method may include selecting the first link for transmission of a first PDU set of the two or more PDU sets based on a PSI associated with the first PDU set having a highest PSI value and the first link providing a higher throughput than the second link. The operations of 2110 may be performed in accordance with examples as disclosed herein. In some examples, aspects of the operations of 2110 may be performed by a link selection component 1230 as described with reference to FIG. 12.

At 2115, the method may include selecting the second link for transmission of a second PDU set of the two or more PDU sets based on the PSI associated with the second PDU set having a lower PSI value than the first PDU set and the second link providing a lower throughput than the first link. The operations of 2115 may be performed in accordance with examples as disclosed herein. In some examples, aspects of the operations of 2115 may be performed by a link selection component 1230 as described with reference to FIG. 12.

At 2120, the method may include outputting the two or more PDU sets for transmission to the UE via the selected links, where different PDU sets within the two or more PDU sets are entirely transmitted via either the first link or the second link, and each PDU of a PDU set is transmitted via a same link. The operations of 2120 may be performed in accordance with examples as disclosed herein. In some examples, aspects of the operations of 2120 may be performed by a link selection component 1230 as described with reference to FIG. 12.

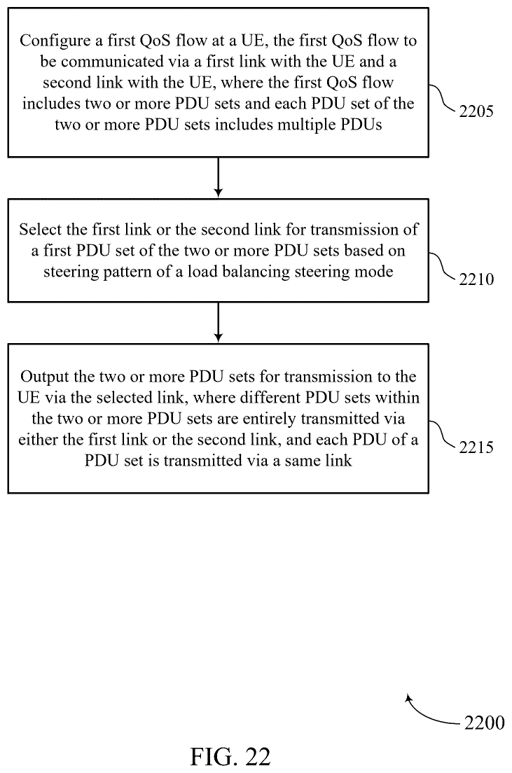

FIG. 22 shows a flowchart illustrating a method 2200 that supports protocol data unit set communications via multiple access links in wireless communications in accordance with one or more aspects of the present disclosure. The operations of the method 2200 may be implemented by a network entity or its components as described herein. For example, the operations of the method 2200 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2205, the method may include configuring a first QoS flow at a UE, the first QoS flow to be communicated via a first link with the UE and a second link with the UE, where the first QoS flow includes two or more PDU sets and each PDU set of the two or more PDU sets includes multiple PDUs. The operations of 2205 may be performed in accordance with examples as disclosed herein. In some examples, aspects of the operations of 2205 may be performed by a QoS flow component 1225 as described with reference to FIG. 12.

At 2210, the method may include selecting the first link or the second link for transmission of a first PDU set of the two or more PDU sets based on steering pattern of a load balancing steering mode. The operations of 2210 may be performed in accordance with examples as disclosed herein. In some examples, aspects of the operations of 2210 may be performed by a link selection component 1230 as described with reference to FIG. 12.

At 2215, the method may include outputting the two or more PDU sets for transmission to the UE via the selected link, where different PDU sets within the two or more PDU sets are entirely transmitted via either the first link or the second link, and each PDU of a PDU set is transmitted via a same link. The operations of 2215 may be performed in accordance with examples as disclosed herein. In some examples, aspects of the operations of 2215 may be performed by a link selection component 1230 as described with reference to FIG. 12.

The following provides an overview of aspects of the present disclosure:

Aspect 1: A method for wireless communications at a UE, comprising: receiving configuration information for a first QoS flow to be communicated via a first link with a network entity and a second link with the network entity, wherein the first QoS flow comprises a plurality of PDU sets and each PDU set of the plurality of PDU sets comprises a plurality of PDUs; and transmitting the plurality of PDU sets to the network entity via one or more of the first link or the second link, wherein different PDU sets within the plurality of PDU sets are entirely transmitted via either the first link or the second link, and each PDU of a PDU set is transmitted via a same link.

Aspect 2: The method of aspect 1, further comprising: selecting the first link for transmission of a first PDU set of the plurality of PDU sets based at least in part on one or more ATSSS rules, and wherein each PDU of the first PDU set is entirely transmitted via the first link; and selecting the second link for transmission of a second PDU set of the plurality of PDU sets based at least in part on the one or more ATSSS rules, and wherein each PDU of the second PDU set is entirely transmitted via the second link.

Aspect 3: The method of any of aspects 1 through 2, wherein the first link provides access to the network entity via a first access link of a cellular network between the UE and the network entity, and the second link provides access to the network entity via either a second access link of the cellular network or a non-cellular link that uses a different radio access technology than the first link.

Aspect 4: The method of any of aspects 1 through 3, wherein the first link provides access to the network entity via a first access link of the UE and the second link provides access to the network entity via a cooperative link with a different UE that has a second access link with the network entity.

Aspect 5: The method of any of aspects 1 through 4, further comprising: selecting the first link for transmission of a first PDU set of the plurality of PDU sets based at least in part on a PSI associated with the first PDU set having a highest PSI value and the first link providing a higher throughput than the second link; and selecting the second link for transmission of a second PDU set of the plurality of PDU sets based at least in part on the PSI associated with the second PDU set having a lower PSI value than the first PDU set and the second link providing a lower throughput than the first link.

Aspect 6: The method of any of aspects 1 through 5, further comprising: selecting one of the first link or the second link for transmission of a first PDU set of the plurality of PDU sets based at least in part on a PSI associated with the first PDU set having a highest PSI value and the first link providing a shorter delay than other available links.

Aspect 7: The method of any of aspects 1 through 6, further comprising: selecting one of the first link or the second link for transmission of a first PDU set of the plurality of PDU sets based at least in part on steering mode rules, wherein the steering mode rules provide prioritization of a link based at least in part on one or more of an available or unavailable link, a round trip time associated with each link, a load balancing target associated with each link, or an assigned priority associated with each link.

Aspect 8: The method of any of aspects 1 through 7, wherein the plurality of PDU sets include a first subset of PDU sets associated with a first multimodal flow of a multimodal service associated with the first QoS flow, and a second subset of PDU sets associated with a second multimodal flow of the multimodal service, and wherein the first subset of PDU sets are mapped to a different link than the second subset of PDU sets.

Aspect 9: The method of aspect 8, further comprising: receiving one or more link reports that indicate one or more of a round trip time or an error rate associated with each of the first link and the second link; and selecting one of the first link or the second link for mapping the first subset of PDU sets based at least in part on the one or more link reports.

Aspect 10: The method of any of aspects 1 through 9, further comprising: selecting the first link or the second link for transmission of a first PDU set of the plurality of PDU sets based at least in part on steering pattern of a load balancing steering mode.

Aspect 11: The method of aspect 10, wherein the steering pattern is indicted in the configuration information as an index value that identifies the steering pattern from multiple available steering patterns, or the steering pattern is provided with a QoS associated with the QoS flow.

Aspect 12: The method of any of aspects 1 through 11, wherein the first link is associated with a first SIM of the UE, and the second link is associated with a second SIM of the UE, and link selection of the first link or the second link for transmission of one or more PDU sets of the plurality of PDU sets is based at least in part on a dual steer profile associated with concurrent connections of the first SIM and the second SIM.

Aspect 13: A method for wireless communications at a network entity, comprising: configuring a first QoS flow at a UE, the first QoS flow to be communicated via a first link with the UE and a second link with the UE, wherein the first QoS flow comprises a plurality of PDU sets and each PDU set of the plurality of PDU sets comprises a plurality of PDUs; and outputting the plurality of PDU sets for transmission to the UE via one or more of the first link or the second link, wherein different PDU sets within the plurality of PDU sets are entirely transmitted via either the first link or the second link, and each PDU of a PDU set is transmitted via a same link.

Aspect 14: The method of aspect 13, further comprising: selecting the first link for transmission of a first PDU set of the plurality of PDU sets based at least in part on one or more ATSSS rules, and wherein each PDU of the first PDU set is entirely transmitted via the first link; and selecting the second link for transmission of a second PDU set of the plurality of PDU sets based at least in part on the one or more ATSSS rules, and wherein each PDU of the second PDU set is entirely transmitted via the second link.

Aspect 15: The method of any of aspects 13 through 14, wherein the first link is a first access link of a cellular network between the UE and the network entity, and the second link provides access to the UE via either a second access link of the cellular network or a non-cellular link that uses a different radio access technology than the first link.

Aspect 16: The method of any of aspects 13 through 15, wherein the UE is a first UE and the first link is a first access link of a cellular network between the first UE and the network entity, and the second link comprises a second access link with a second UE and a cooperative link between the first UE and the second UE.

Aspect 17: The method of any of aspects 13 through 16, further comprising: selecting the first link for transmission of a first PDU set of the plurality of PDU sets based at least in part on a PSI associated with the first PDU set having a highest PSI value and the first link providing a higher throughput than the second link; and selecting the second link for transmission of a second PDU set of the plurality of PDU sets based at least in part on the PSI associated with the second PDU set having a lower PSI value than the first PDU set and the second link providing a lower throughput than the first link.

Aspect 18: The method of any of aspects 13 through 17, further comprising: selecting one of the first link or the second link for transmission of a first PDU set of the plurality of PDU sets based at least in part on a PSI associated with the first PDU set having a highest PSI value and the first link providing a shorter delay than other available links.

Aspect 19: The method of any of aspects 13 through 18, further comprising: selecting one of the first link or the second link for transmission of a first PDU set of the plurality of PDU sets based at least in part on steering mode rules, wherein the steering mode rules provide prioritization of a link based at least in part on one or more of an available or unavailable link, a round trip time associated with each link, a load balancing target associated with each link, or an assigned priority associated with each link.

Aspect 20: The method of any of aspects 13 through 19, wherein the plurality of PDU sets include a first subset of PDU sets associated with a first multimodal flow of a multimodal service associated with the first QoS flow, and a second subset of PDU sets associated with a second multimodal flow of the multimodal service, and wherein the first subset of PDU sets are mapped to a different link than the second subset of PDU sets.

Aspect 21: The method of aspect 20, further comprising: obtaining one or more link reports that indicate one or more of a round trip time or an error rate associated with each of the first link and the second link; and selecting one of the first link or the second link for mapping the first subset of PDU sets based at least in part on the one or more link reports.

Aspect 22: The method of any of aspects 13 through 21, further comprising: selecting the first link or the second link for transmission of a first PDU set of the plurality of PDU sets based at least in part on steering pattern of a load balancing steering mode.

Aspect 23: The method of aspect 22, wherein the steering pattern is indicted in configuration information provided to the UE as an index value that identifies the steering pattern from multiple available steering patterns, or the steering pattern is provided with a QoS associated with the QoS flow.

Aspect 24: The method of any of aspects 13 through 23, wherein the first link is associated with a first SIM of the UE, and the second link is associated with a second SIM of the UE, and link selection of the first link or the second link for transmission of one or more PDU sets of the plurality of PDU sets is based at least in part on a dual steer profile associated with concurrent connections of the first SIM and the second SIM.

Aspect 25: A UE for wireless communications, comprising one or more memories storing processor-executable code, and one or more processors coupled with the one or more memories and individually or collectively operable to execute the code to cause the UE to perform a method of any of aspects 1 through 12.

Aspect 26: A UE for wireless communications, comprising at least one means for performing a method of any of aspects 1 through 12.

Aspect 27: A non-transitory computer-readable medium storing code for wireless communications, the code comprising instructions executable by one or more processors to perform a method of any of aspects 1 through 12.

Aspect 28: A network entity for wireless communications, comprising one or more memories storing processor-executable code, and one or more processors coupled with the one or more memories and individually or collectively operable to execute the code to cause the network entity to perform a method of any of aspects 13 through 24.

Aspect 29: A network entity for wireless communications, comprising at least one means for performing a method of any of aspects 13 through 24.

Aspect 30: A non-transitory computer-readable medium storing code for wireless communications, the code comprising instructions executable by one or more processors to perform a method of any of aspects 13 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information for a first quality of service (QoS) flow to be communicated via a first link with a network entity and a second link with the network entity, wherein the first QoS flow comprises a plurality of protocol data unit (PDU) sets and each PDU set of the plurality of PDU sets comprises a plurality of PDUs; and
transmit the plurality of PDU sets to the network entity via one or more of the first link or the second link, wherein different PDU sets within the plurality of PDU sets are entirely transmitted via either the first link or the second link, and each PDU of a PDU set is transmitted via a same link.

2. The UE of claim 1, wherein the one or more processors are individually or collectively further operable to execute the code to cause the UE to:
select the first link for transmission of a first PDU set of the plurality of PDU sets based at least in part on one or more access traffic steering-switching-splitting (ATSSS) rules, and wherein each PDU of the first PDU set is entirely transmitted via the first link; and
select the second link for transmission of a second PDU set of the plurality of PDU sets based at least in part on the one or more ATSSS rules, and wherein each PDU of the second PDU set is entirely transmitted via the second link.

3. The UE of claim 1, wherein the first link provides access to the network entity via a first access link of a cellular network between the UE and the network entity, and the second link provides access to the network entity via either a second access link of the cellular network or a non-cellular link that uses a different radio access technology than the first link.

4. The UE of claim 1, wherein the first link provides access to the network entity via a first access link of the UE and the second link provides access to the network entity via a cooperative link with a different UE that has a second access link with the network entity.

5. The UE of claim 1, wherein the one or more processors are individually or collectively further operable to execute the code to cause the UE to:
select the first link for transmission of a first PDU set of the plurality of PDU sets based at least in part on a PDU set importance (PSI) associated with the first PDU set having a highest PSI value and the first link providing a higher throughput than the second link; and
select the second link for transmission of a second PDU set of the plurality of PDU sets based at least in part on the PSI associated with the second PDU set having a lower PSI value than the first PDU set and the second link providing a lower throughput than the first link.

6. The UE of claim 1, wherein the one or more processors are individually or collectively further operable to execute the code to cause the UE to:
select one of the first link or the second link for transmission of a first PDU set of the plurality of PDU sets based at least in part on a PDU set importance (PSI) associated with the first PDU set having a highest PSI value and the first link providing a shorter delay than other available links.

7. The UE of claim 1, wherein the one or more processors are individually or collectively further operable to execute the code to cause the UE to:
select one of the first link or the second link for transmission of a first PDU set of the plurality of PDU sets based at least in part on steering mode rules, wherein the steering mode rules provide prioritization of a link based at least in part on one or more of an available or unavailable link, a round trip time associated with each link, a load balancing target associated with each link, or an assigned priority associated with each link.

8. The UE of claim 1, wherein the plurality of PDU sets include a first subset of PDU sets associated with a first multimodal flow of a multimodal service associated with the first QoS flow, and a second subset of PDU sets associated with a second multimodal flow of the multimodal service, and wherein the first subset of PDU sets are mapped to a different link than the second subset of PDU sets.

9. The UE of claim 8, wherein the one or more processors are individually or collectively further operable to execute the code to cause the UE to:
receive one or more link reports that indicate one or more of a round trip time or an error rate associated with each of the first link and the second link; and
select one of the first link or the second link for mapping the first subset of PDU sets based at least in part on the one or more link reports.

10. The UE of claim 1, wherein the one or more processors are individually or collectively further operable to execute the code to cause the UE to:
select the first link or the second link for transmission of a first PDU set of the plurality of PDU sets based at least in part on steering pattern of a load balancing steering mode.

11. The UE of claim 10, wherein the steering pattern is indicted in the configuration information as an index value that identifies the steering pattern from multiple available steering patterns, or the steering pattern is provided with a QoS associated with the QoS flow.

12. The UE of claim 1, wherein the first link is associated with a first subscriber identification module (SIM) of the UE, and the second link is associated with a second SIM of the UE, and link selection of the first link or the second link for transmission of one or more PDU sets of the plurality of PDU sets is based at least in part on a dual steer profile associated with concurrent connections of the first SIM and the second SIM.

13. A method for wireless communications at a user equipment (UE), comprising:
receiving configuration information for a first quality of service (QoS) flow to be communicated via a first link with a network entity and a second link with the network entity, wherein the first QoS flow comprises a plurality of protocol data unit (PDU) sets and each PDU set of the plurality of PDU sets comprises a plurality of PDUs; and
transmitting the plurality of PDU sets to the network entity via one or more of the first link or the second link, wherein different PDU sets within the plurality of PDU sets are entirely transmitted via either the first link or the second link, and each PDU of a PDU set is transmitted via a same link.

14. The method of claim 13, further comprising:
selecting the first link for transmission of a first PDU set of the plurality of PDU sets based at least in part on one or more access traffic steering-switching-splitting (ATSSS) rules, and wherein each PDU of the first PDU set is entirely transmitted via the first link; and
selecting the second link for transmission of a second PDU set of the plurality of PDU sets based at least in part on the one or more ATSSS rules, and wherein each PDU of the second PDU set is entirely transmitted via the second link.

15. The method of claim 13, further comprising:
selecting the first link for transmission of a first PDU set of the plurality of PDU sets based at least in part on a PDU set importance (PSI) associated with the first PDU set having a highest PSI value and the first link providing a higher throughput than the second link; and
selecting the second link for transmission of a second PDU set of the plurality of PDU sets based at least in part on the PSI associated with the second PDU set having a lower PSI value than the first PDU set and the second link providing a lower throughput than the first link.

16. The method of claim 13, further comprising:
selecting one of the first link or the second link for transmission of a first PDU set of the plurality of PDU sets based at least in part on a PDU set importance (PSI) associated with the first PDU set having a highest PSI value and the first link providing a shorter delay than other available links.

17. The method of claim 13, further comprising:
selecting the first link or the second link for transmission of a first PDU set of the plurality of PDU sets based at least in part on steering pattern of a load balancing steering mode.

18. A non-transitory computer-readable medium storing code for wireless communications, the code comprising instructions executable by one or more processors to:
receive configuration information for a first quality of service (QoS) flow to be communicated via a first link with a network entity and a second link with the network entity, wherein the first QoS flow comprises a plurality of protocol data unit (PDU) sets and each PDU set of the plurality of PDU sets comprises a plurality of PDUs; and
transmit the plurality of PDU sets to the network entity via one or more of the first link or the second link, wherein different PDU sets within the plurality of PDU sets are entirely transmitted via either the first link or the second link, and each PDU of a PDU set is transmitted via a same link.

19. The non-transitory computer-readable medium of claim 18, wherein the instructions are further executable by the one or more processors to:
select the first link for transmission of a first PDU set of the plurality of PDU sets based at least in part on one or more access traffic steering-switching-splitting (ATSSS) rules, and wherein each PDU of the first PDU set is entirely transmitted via the first link; and
select the second link for transmission of a second PDU set of the plurality of PDU sets based at least in part on the one or more ATSSS rules, and wherein each PDU of the second PDU set is entirely transmitted via the second link.

20. The non-transitory computer-readable medium of claim 18, wherein the instructions are further executable by the one or more processors to:
select the first link for transmission of a first PDU set of the plurality of PDU sets based at least in part on a PDU set importance (PSI) associated with the first PDU set having a highest PSI value and the first link providing a higher throughput than the second link; and
select the second link for transmission of a second PDU set of the plurality of PDU sets based at least in part on the PSI associated with the second PDU set having a lower PSI value than the first PDU set and the second link providing a lower throughput than the first link.
